(19) United States
(12) Patent Application Publication
(10) Pub. No.: US 2009/0010404 A1
(43) Pub. Date: Jan. 8, 2009

(54) SYSTEMS AND METHODS FOR PROVIDING ANONYMOUS CALLING

(76) Inventor: Nicholas Zazza, Freehold, NJ (US)

Correspondence Address: MEREDITH & KEYHANI, PLLC, 330 MADISON AVE., 6TH FLOOR, NEW YORK, NY, 10017, US

(21) Appl. No.: 11/877,638

(22) Filed: Oct. 23, 2007

Related U.S. Application Data
(60) Provisional application No. 60/863,934, filed on Nov. 1, 2006.

(51) Int. Cl. H04M 11/00

(52) U.S. Cl. 379/93.01

(57) ABSTRACT

A method of providing anonymous calling comprising the steps of: providing a first user having a first user ID associated with a first phone number; providing a second user having a second user ID associated with a destination phone number; accepting a call request from the first user containing the second user ID; receiving in a computer based system a call request, checking whether the destination phone number is a paid plan or free plan, and wherein the first user is on a free plan, an advertisement is played to the initiating user prior to placing phone call and wherein the first user is on a paid plan the advertisement is not played and the first user is called to provide an anonymous phone connection between the first user and the destination phone number.

This application claims priority to application No. 60/863,934 filed Nov. 1, 2006 entitled “DIGICLICK”.

The present invention relates generally telecommunications and more specifically to systems and methods for providing anonymous calling.

Typically, phone calls are made by one user dialing the telephone number of a second user. However, it would be desirable to be able to get a user ID and have other users call the userID for many reasons. This will create marketing and privacy advantages by allowing the first user to call the second user without having an actual phone number. Further, the users may use their User ID as a form of marketing. For example, the user may choose FIRSTCLASSCLEANERS as their user ID for a cleaning company. In a business with many different partners, they may want to have certain days that new clients call one partner to field new customers and other days the other partner receives incoming new client calls. The phone number associated with the userID may be changed, but the new customers never know this. They may also very easily remember how to contact the company and/or individuals, rather than having to remember ten digits. This is also particularly useful given that many people use mobile phones with different area codes requiring people to remember ten digits instead of seven. There are many ways it can be envisioned that this would be useful.

Another problem with the prior art is that individuals surfing the web often find a phone number for a business or a person (on personal websites such as myspace, etc.). It may be desirable for the business or individual to keep their personal phone number private and only allow calls through anonymous userID or by clicking on a link.

Accordingly, the present invention provides systems and methods for providing anonymous calling and marketing.

### SUMMARY OF THE INVENTION

The present invention relates generally to systems and methods relating to telecommunications.

According to one embodiment, a method of providing anonymous calling is disclosed, the method comprising the steps of: providing a first user having a first user ID associated with a first phone number; providing a second user having a second user ID associated with a destination phone number; accepting an call request from the first user containing the second user ID; receiving in a computer based system the call request, wherein the computer based system checks to inquire whether the destination phone number is registered with the computer based system, wherein the destination phone number is not registered the first user is notified that the second userID is invalid, wherein the destination phone number is registered, the method comprises the step determining whether the first user is on a paid plan or a free plan, and wherein the first user is on a free plan, an advertisement is played to the initiating user prior to placing phone call and wherein the first user is on a paid plan the advertisement is not played and the first user is called; calling the destination phone number to provide an anonymous phone connection between the first user and the destination phone number.

According to another embodiment, a method of providing anonymous calling is disclosed, the method comprising the steps of: providing a first user having a first user ID associated with a first phone number; providing a second user having a second user ID associated with a destination phone number; accepting a text message from the first user containing the second user ID; determining the destination phone number locale status, wherein the destination phone number locale status is either domestic or international; wherein the destination phone number locale status is international, the method further comprises the step of determining the first users membership status, the first users membership status being selected from the group consisting of registered and paying, registered and free or unregistered; and wherein the first users membership status is registered and paying the step of calling the destination phone number is completed; wherein the first users membership status is registered and free the step of playing an advertisement to the user is performed and the step of calling the destination phone number is completed; wherein the first users membership status is unregistered, the initiating user is directed towards a membership application and the step of calling the destination phone number is not completed until the membership status is either registered and paying or registered and free; determining the destination membership status of the second destination phone number, wherein the destination membership status is either registered or unregistered; wherein the destination membership status is registered the computer based system calls the destination phone number and an anonymous phone connection between the first user and the second user is completed; wherein the aid origination membership status is unregistered, the computer based system informs the connection cannot be made.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention;

FIG. 4 depicts the present invention;

FIG. 5 depicts the present invention;

FIG. 6 depicts the present invention;

FIG. 7 depicts the present invention;

FIG. 8 depicts the present invention;

FIG. 9 depicts the present invention;

FIG. 10 depicts the present invention;

FIG. 11 depicts the present invention;

FIG. 12 depicts the present invention;

FIG. 13 depicts the present invention;

FIG. 14 depicts the present invention;

FIG. 15 depicts the present invention;

FIG. 16 depicts the present invention;

FIG. 17 depicts the present invention;

FIG. 18 depicts the present invention;

FIG. 19 depicts the present invention;

FIG. 20 depicts the present invention;

FIG. 21 depicts the present invention;

FIG. 22 depicts the present invention;

FIG. 23 depicts the present invention;

FIG. 24 depicts the present invention;

FIG. 25 depicts the present invention;

FIG. 26 depicts the present invention;

FIG. 27 depicts the present invention;

FIG. 28 depicts the present invention;

FIG. 29 depicts the present invention;

FIG. 30 depicts the present invention;

FIG. 31 depicts the present invention;

FIG. 32 depicts the present invention;

FIG. 33 depicts the present invention;

FIG. 34 depicts the present invention;

FIG. 35 depicts the present invention;

FIG. 36 depicts the present invention;

FIG. 37 depicts the present invention;

FIG. 38 depicts the present invention; and

FIG. 39 depicts the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

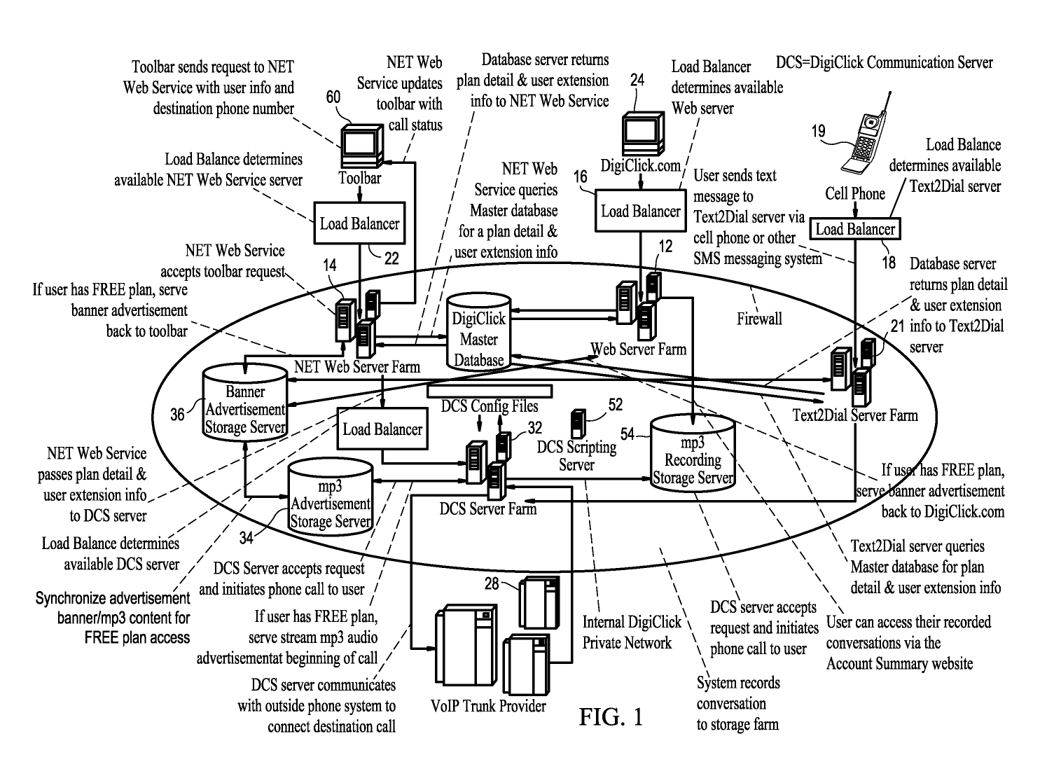

FIG. 1 depicts a system for providing anonymous calling as in the present invention. The system comprising: a master database (10); at least one server farm (12, 14, 32); at least one load balancer (16, 18, 20, 22); a web page (24); config files (26); VoIP trunk provider (28); at least one advertisement storage server (34, 36); and wherein a first user performs a call request, one of the load balancers (16, 18, 20, 22) determines the available server in the server farm (12, 14, 32) the available server accepts the call request and determines from the master database (10) the first user's plan. The first user has a free plan, the at least one advertisement storage server (34, 36) plays the advertisement (which may be, for example, an audio, video or banner advertisement). The load balancer (20) determines the available server in the at least one server farm (32) and the at least one server farm (32) communicates with a phone system to connect a call to a second user to provide a phone connection. The call request may be accepted through a toolbar (50) on a user's computer. The call request may also be accepted though an input device, such as mobile phone (19) via text message, in which case a load balancer (18) determines the available server on a second server farm (21). There may also be a scripting server (52) for providing messages to users. For example, if the first user texts a userID that is unknown, the system may play a message that says, “User id unknown”. The system may also have an audio call recording storage server (54) for recording the phone connection.

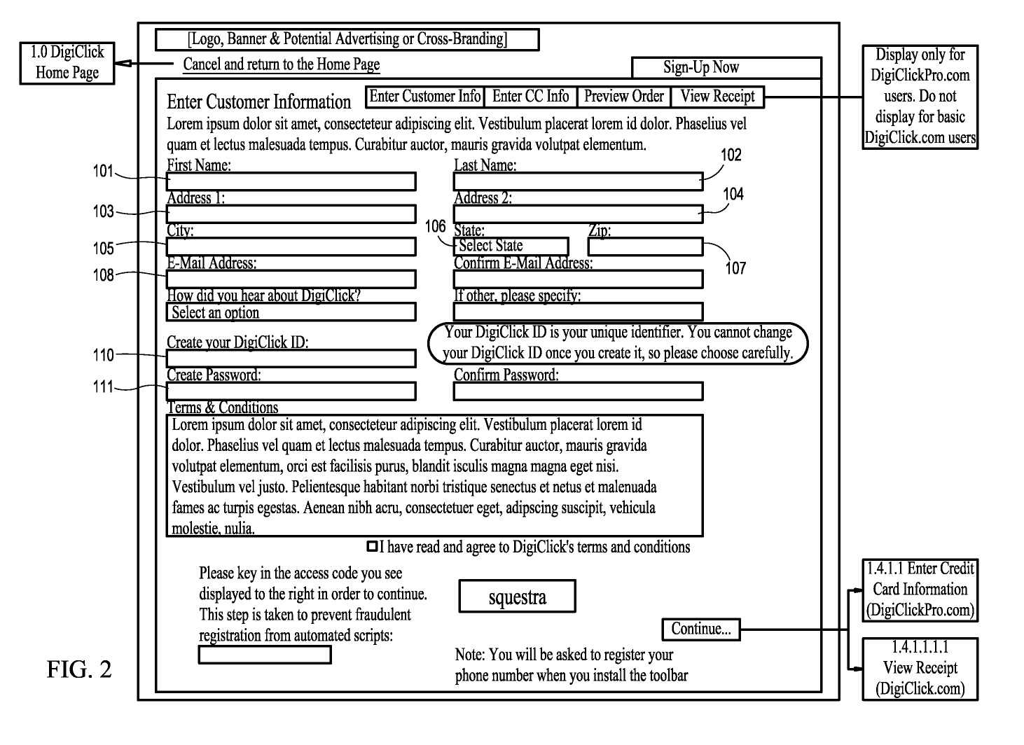

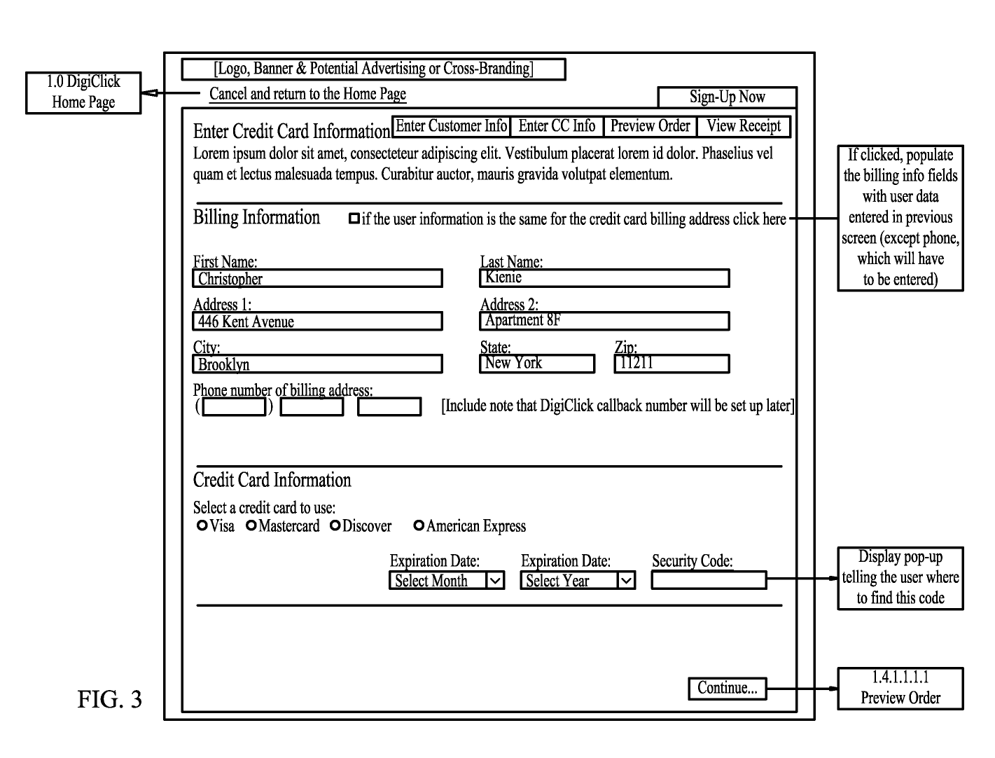

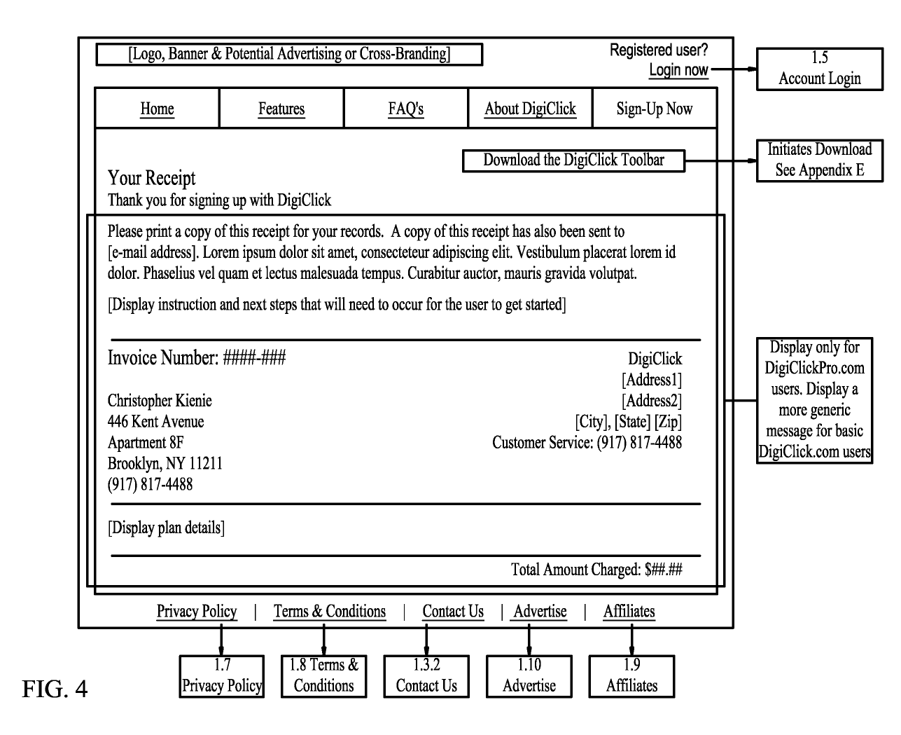

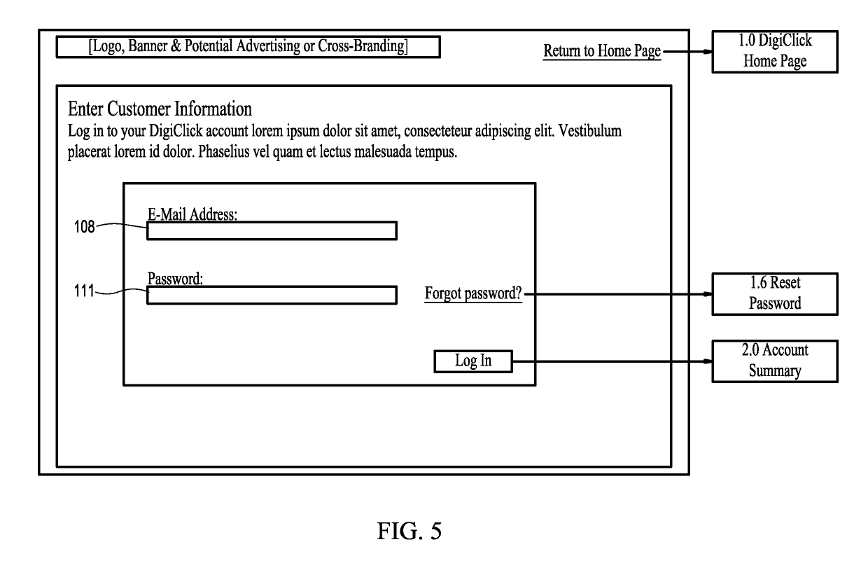

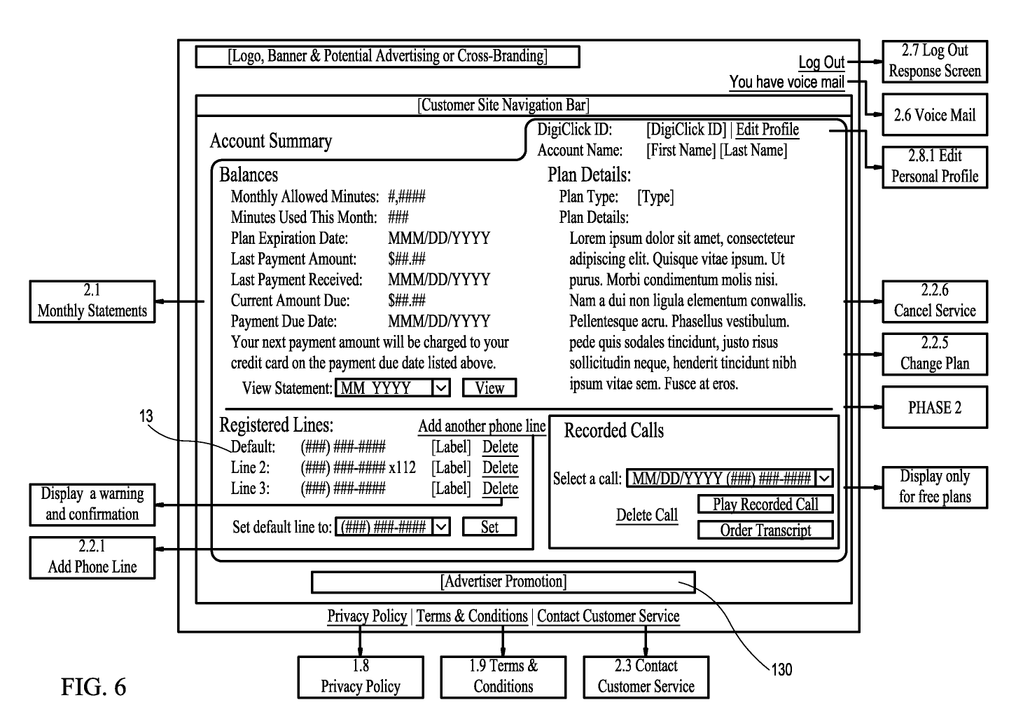

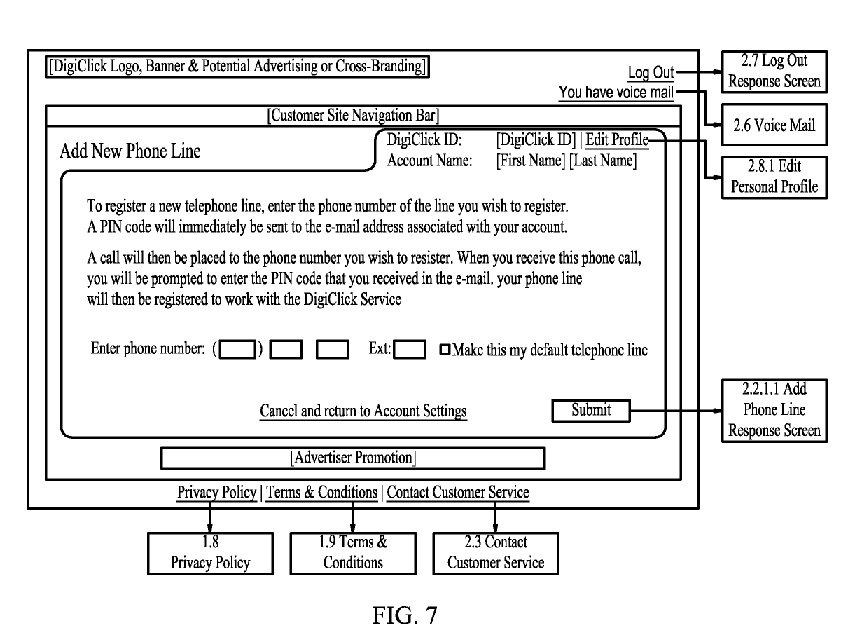

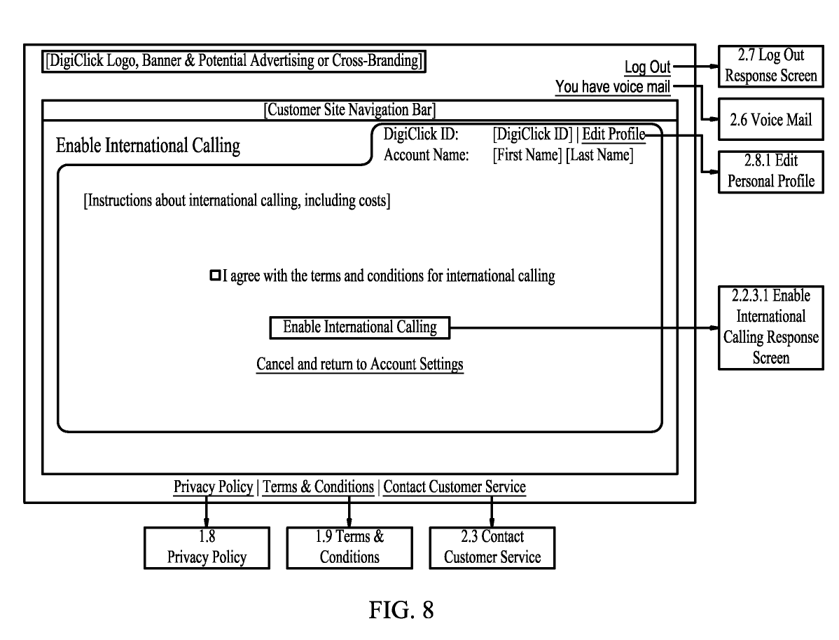

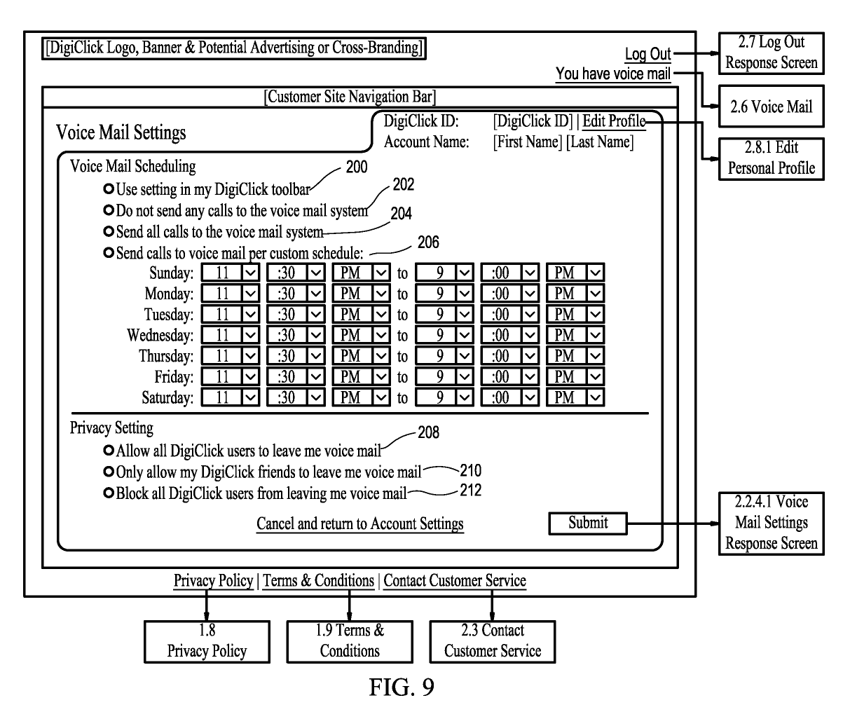

A method of providing anonymous calling, the method comprising the steps of: providing a first user having a first user ID associated with a first phone number. FIG. 2 depicts how a first user may obtain a first user ID. The user may go to a web site, and input their first name (101), last name (102), address1 (103), address2 (104), city (105), State (106), zip (107), email address (108), firstuser ID (110), password (111). The first user may enter into a paid plan or a free plan. If the first user enters into a paid plan, they are required to input their billing information, as shown in FIGS. 3-4. A call may be initiating by a call requests in a number of different ways. There may be a toolbar (50) installed on the first users computer, The user may login, as shown in FIG. 5 by entering their email address (108) and password (111). As shown in FIG. 6, advertisements (130) may be played throughout the users account pages. There may also be a number of different phone numbers (132) associated with a user id. The user selects a first phone number, though for calls to be received on. This may be changed through the website interface. It is also envisioned that different call features may be used to reach the first user, but at least one first phone number is associated with the first user ID. For example, the first user ID may be associated with three registered lines and ring at all three simultaneously, or call each phone number in order ringing three rings, if unanswered then going to the destination phone number and ringing three rings and if unanswered ringing at the third phone number. At any point, a new phone line can be added (as shown in FIG. 7) or removed. Also, the first user may enable international calling, as shown in FIG. 8. As shown in FIG. 9, the voicemail may also be set according to the user's preferences. For example, the user may request to use setting in the toolbar (200), do not send any calls to the voice mail system (202), send all calls to the voice mail system (204), send calls to voice mail per custom schedule (206). The user may also select privacy settings, such as allow all registered users to leave voicemails (208), only allow my registered friends to leave voicemail (210), block all registered users from leaving voice mail (212). According to a preferred embodiment, the first user ID and the second user ID are not phone numbers, but rather may be email addresses or user ID's such as an alphanumeric combination (e.g. tommy77).

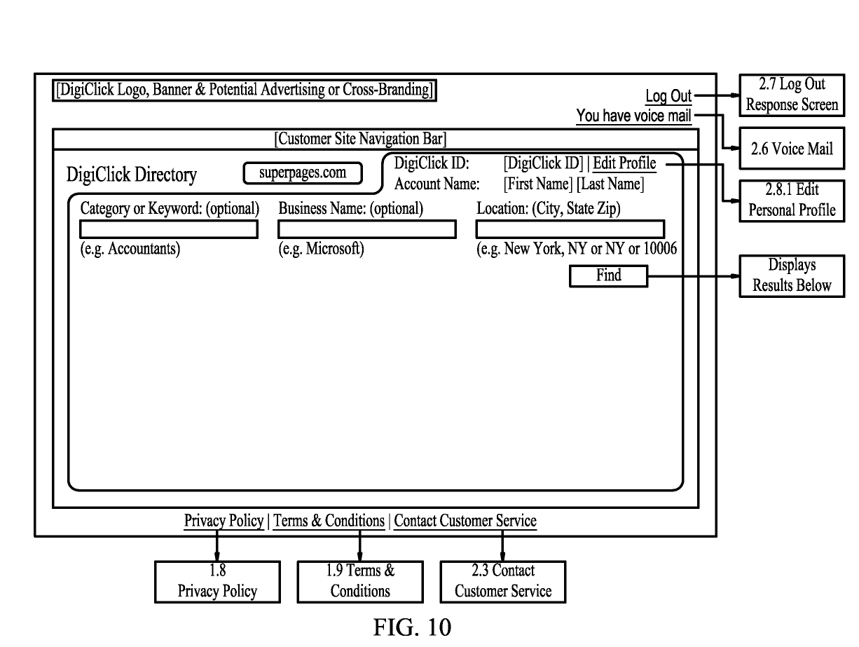

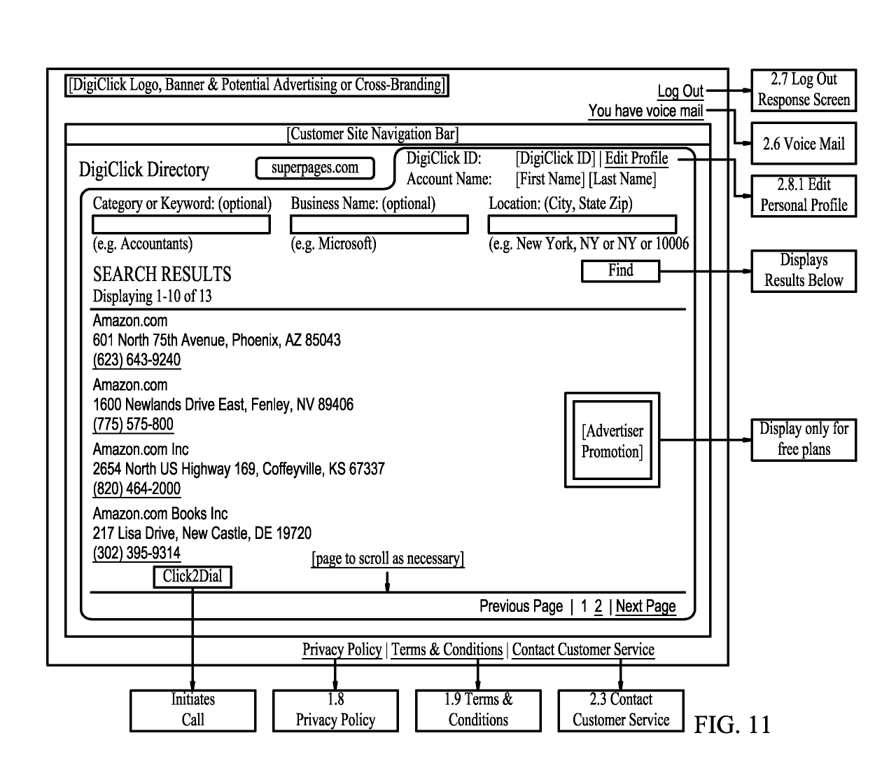

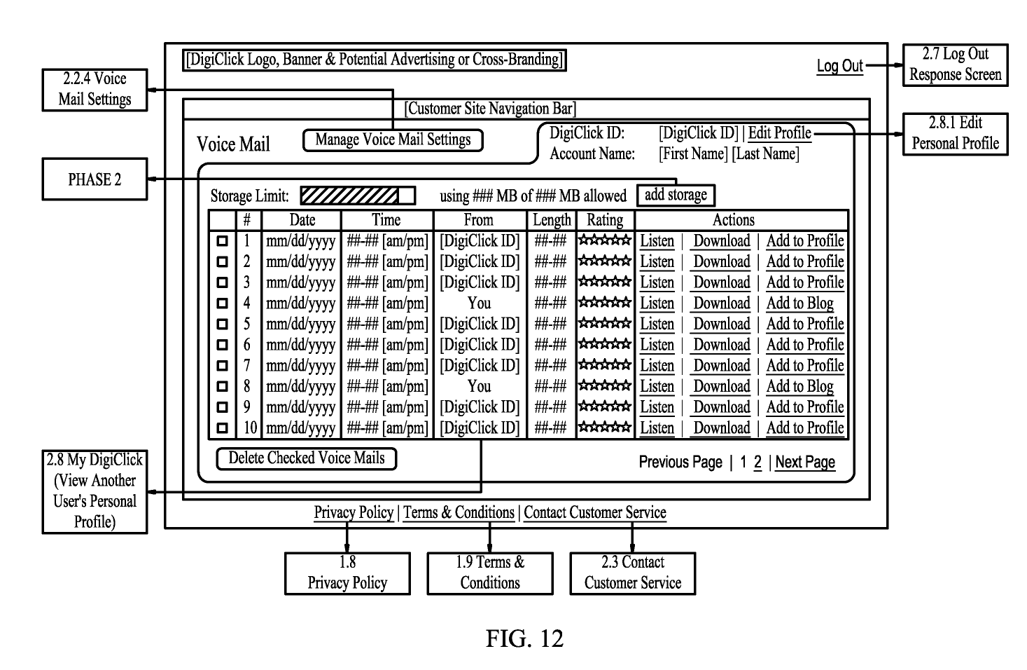

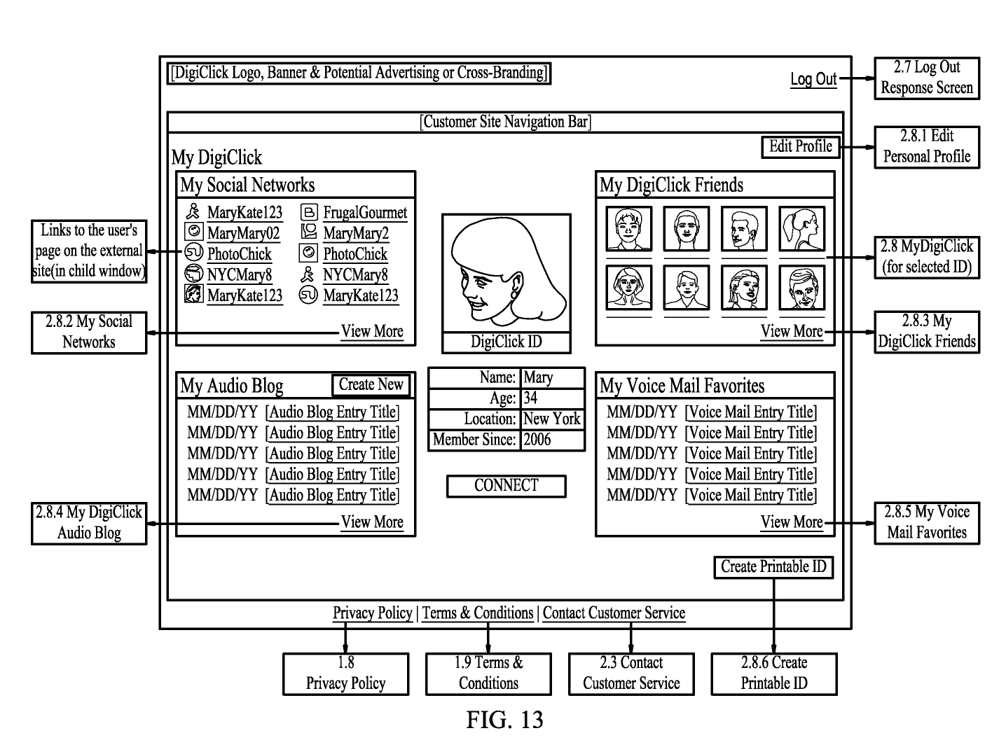

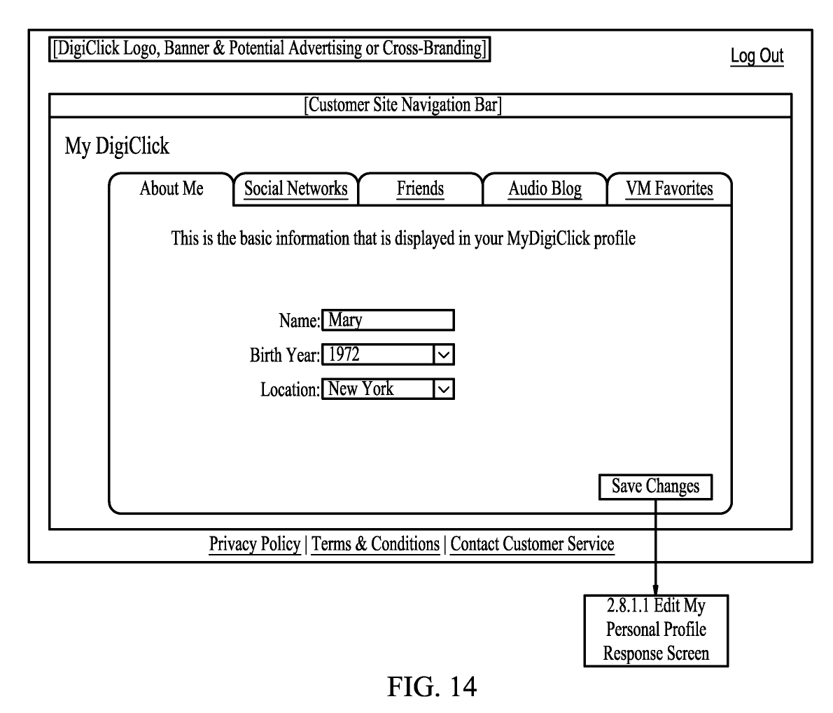

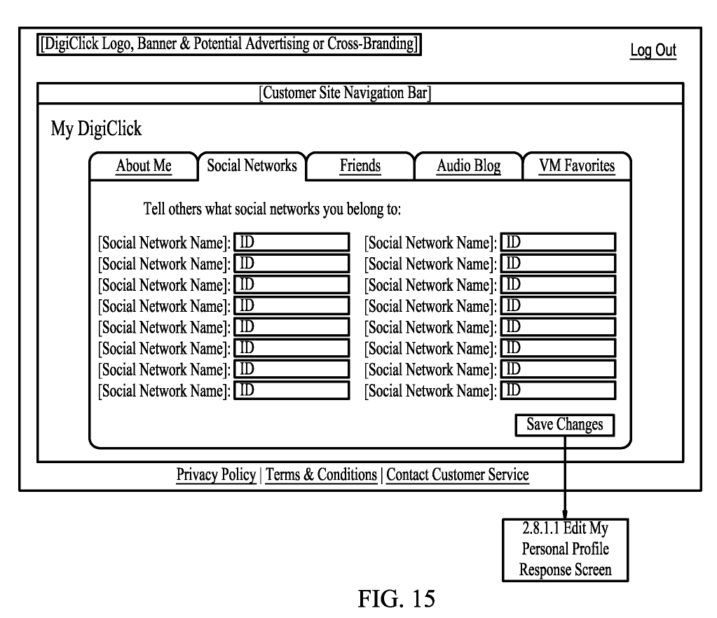

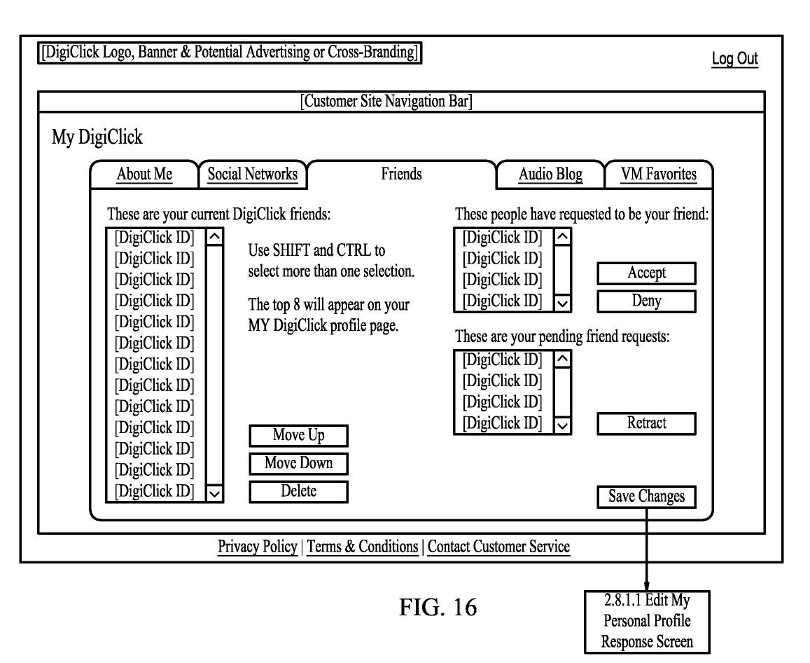

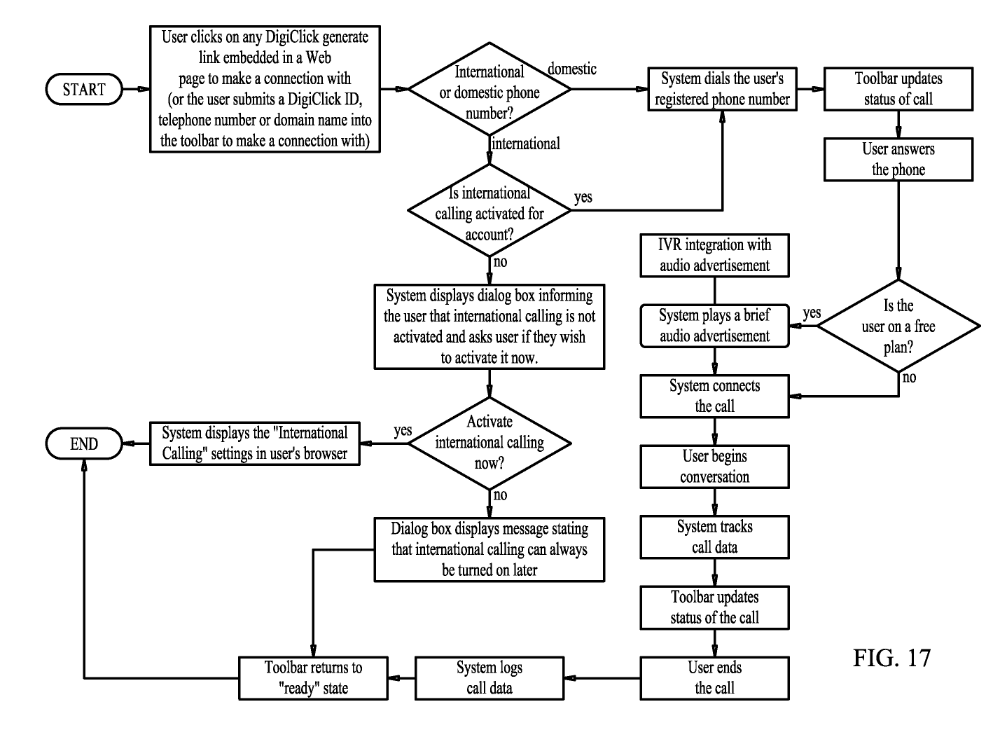

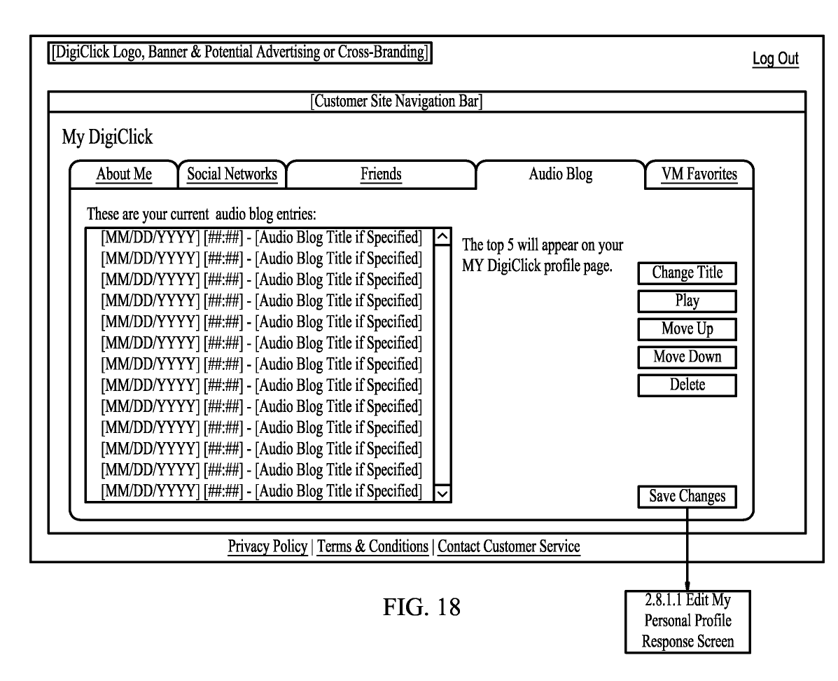

As shown in FIGS. 10-11, there may be a registered user directory showing companies and/or individuals by userID. It may be searched by business type and serve as advertising for the businesses. In this way, user can just click on the business userid, their telephone will ring and the business telephone will ring to connect the user with the business they wish to reach.

According to the present invention, a second user having a second user ID associated with a destination phone number is provided. This may be an individual, for example who chooses the second user ID “Golfer”. The first user would text the word “golfer” into their mobile phone (or computer). The method would comprise the step of accepting a text message from the first user containing the second user ID and receiving in a computer based system the text message. The computer based system would check to inquire whether the destination phone number (“GOLFER”) is registered the system, wherein the destination phone number is not registered the first user is notified that the second userID is invalid, wherein the destination phone number is registered, the method comprises the step determining whether the first user is on a paid plan or a free plan. When the first user is on a free plan, an advertisement is played to the first user or initiating user prior to placing phone call and wherein the first user is on a paid plan the advertisement is not played and the first user is called. The advertisement may be played on the users mobile phone, any hand held device or computer, or any of these methods simultaneously depending on the advertiser and whether the first user is inputting the call request in their computer or their telephone via text message. Then the step of calling the destination phone number is performed to provide an anonymous phone connection between the first user and the destination phone number. This is useful because it uses a first user and second users existing telephones. That is, they can have any type of phone and the system will call that phone number. It could be a mobile phone, a VoIP phone, a standard land line, any technology the user prefers.

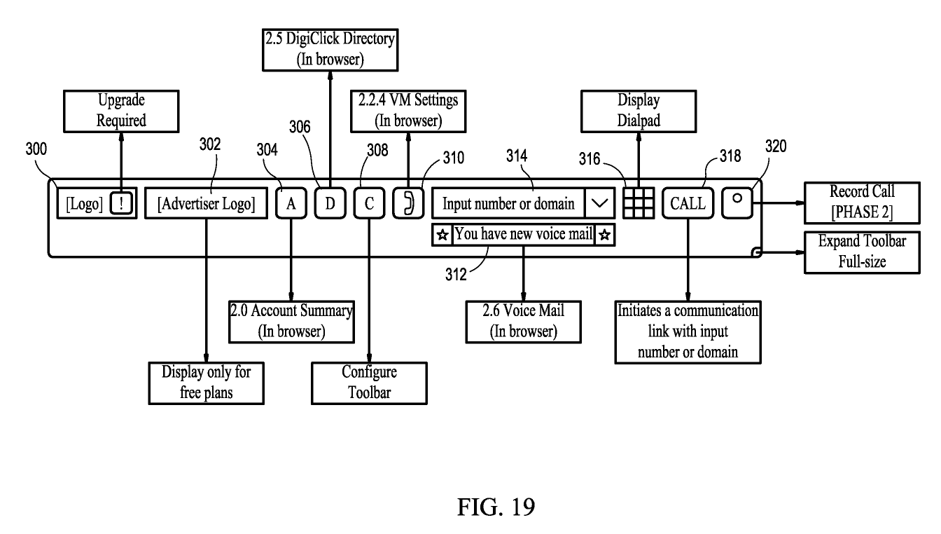

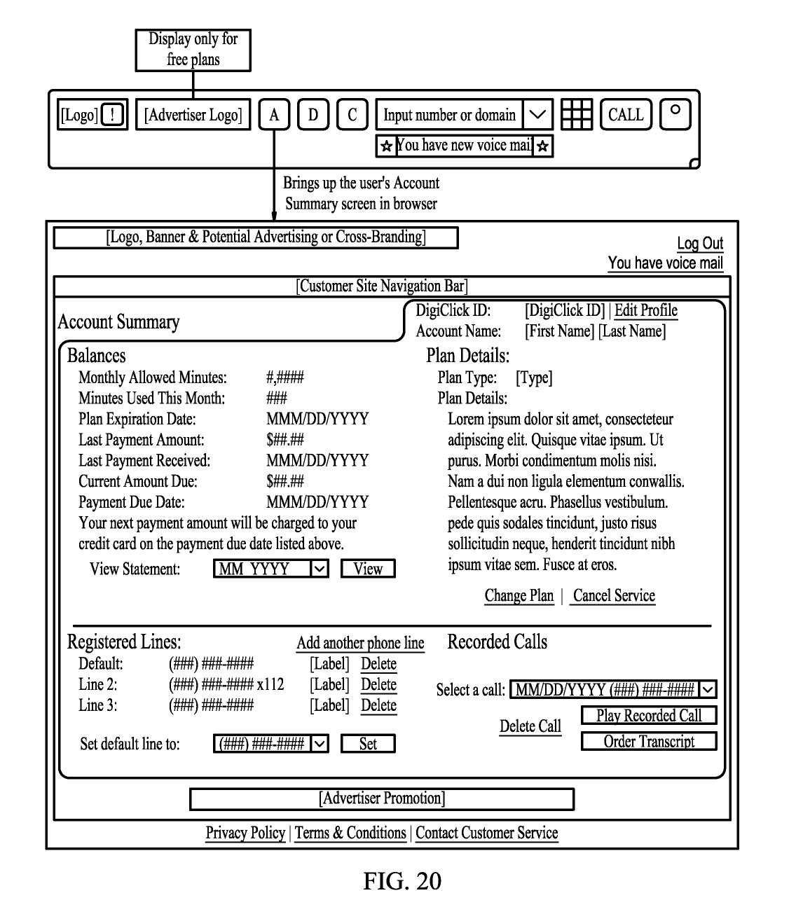

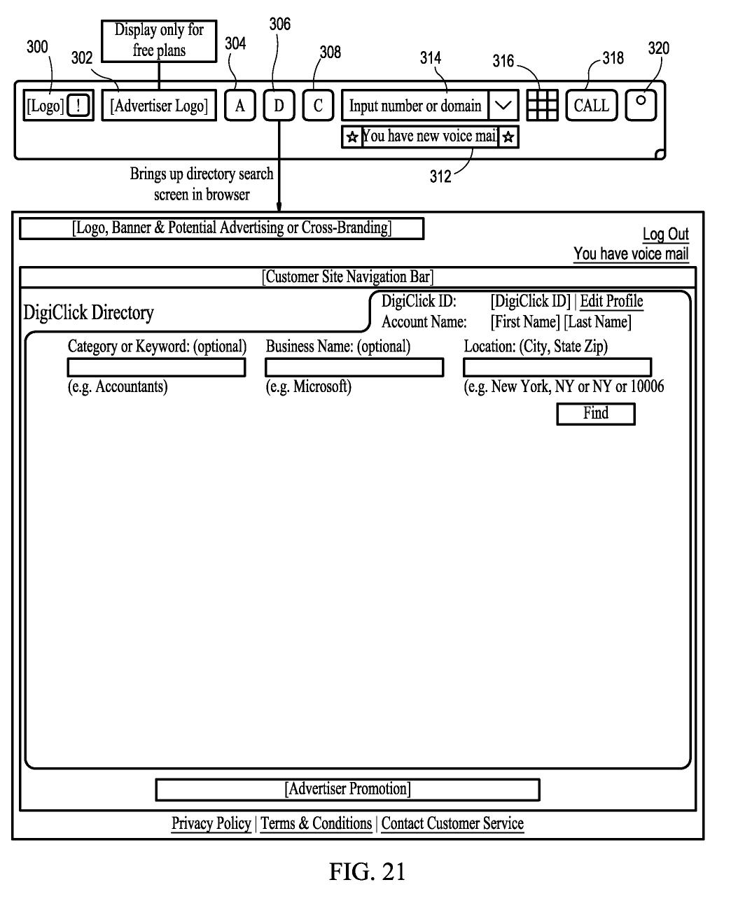

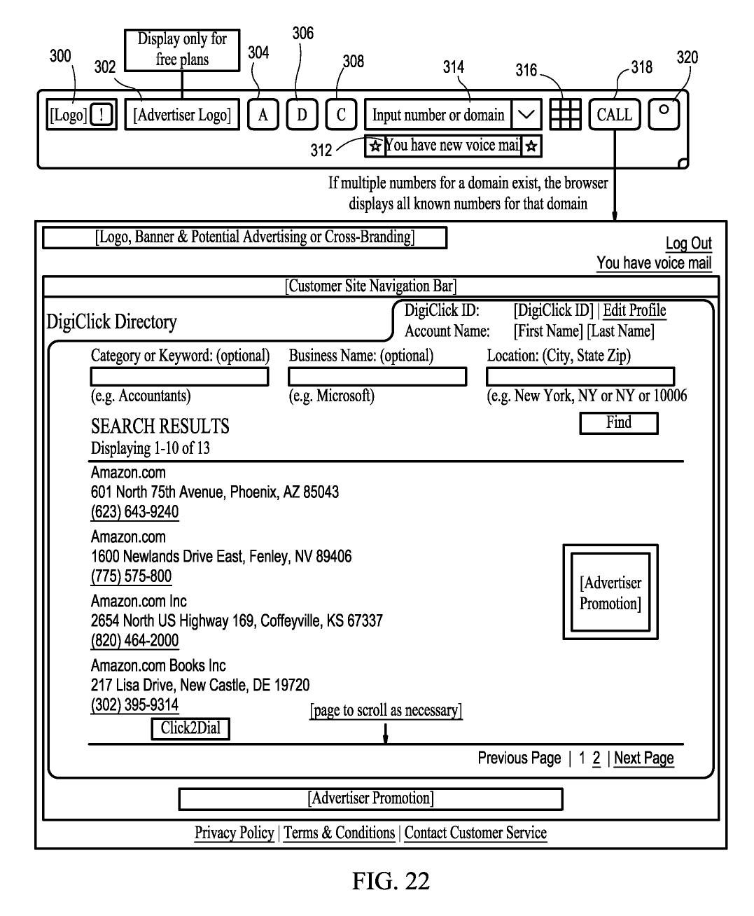

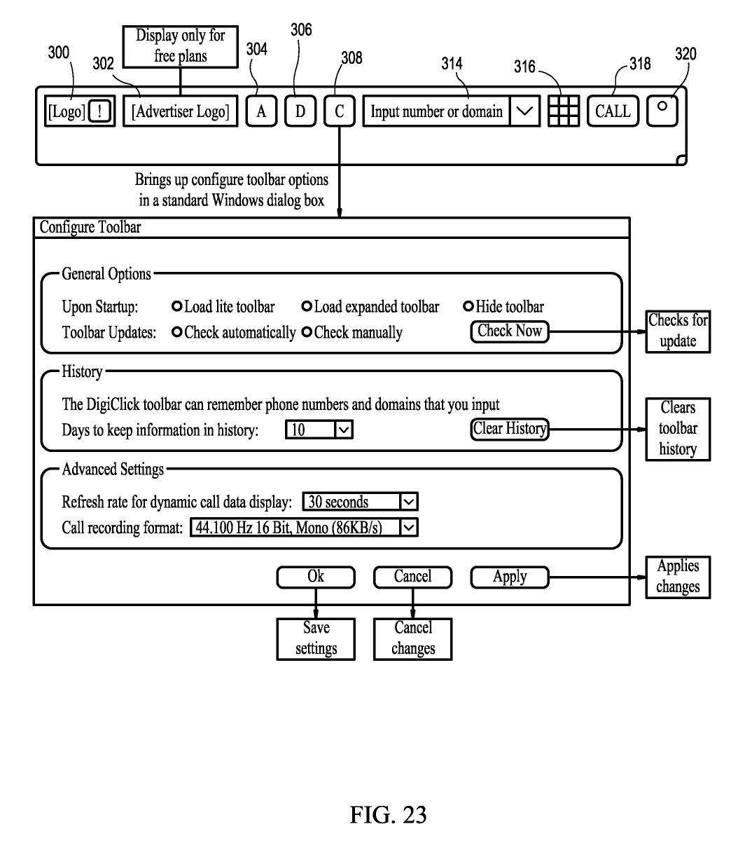

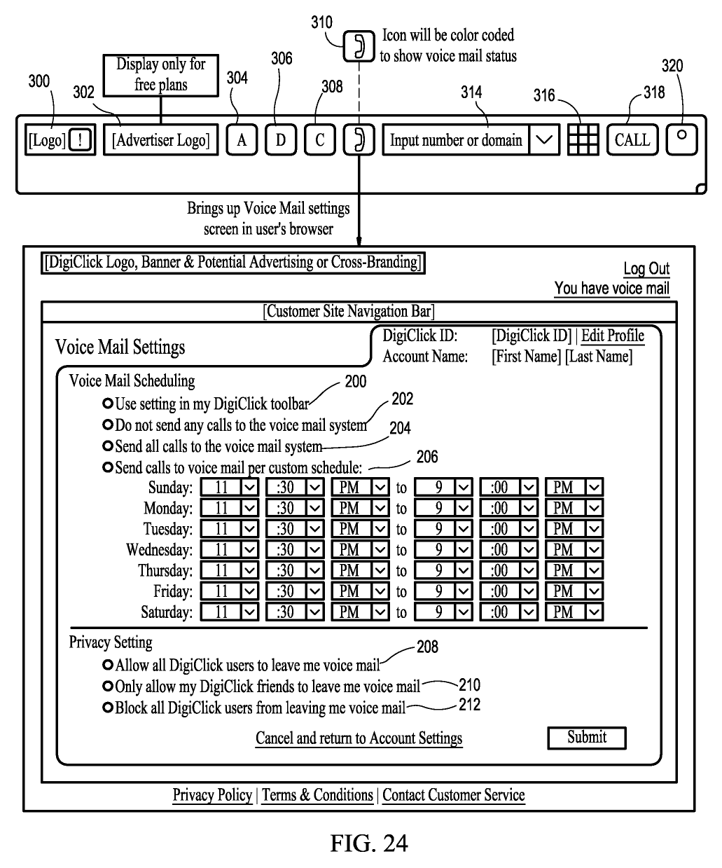

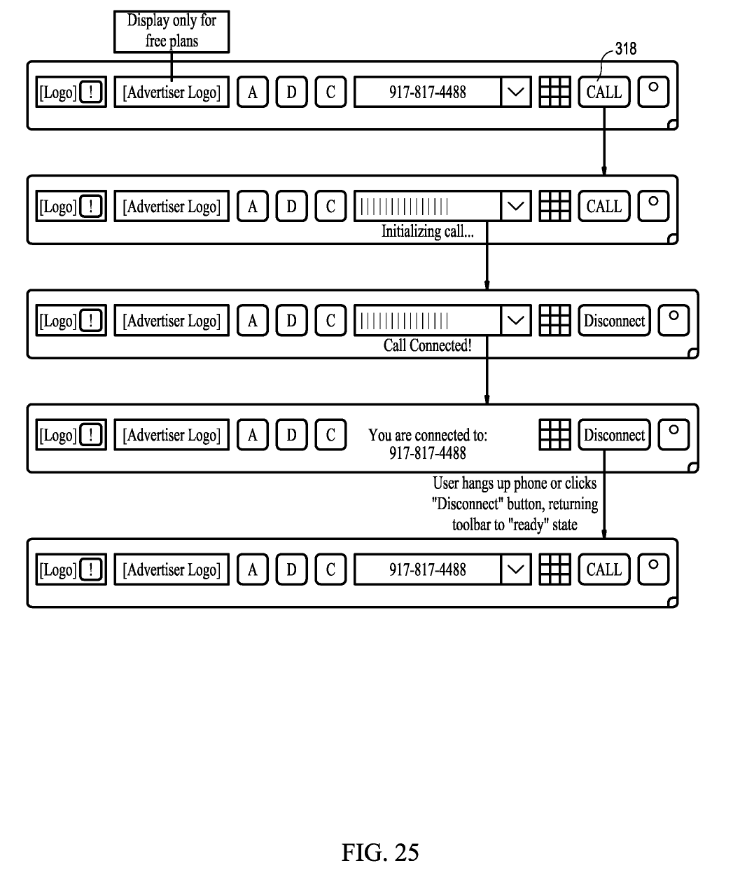

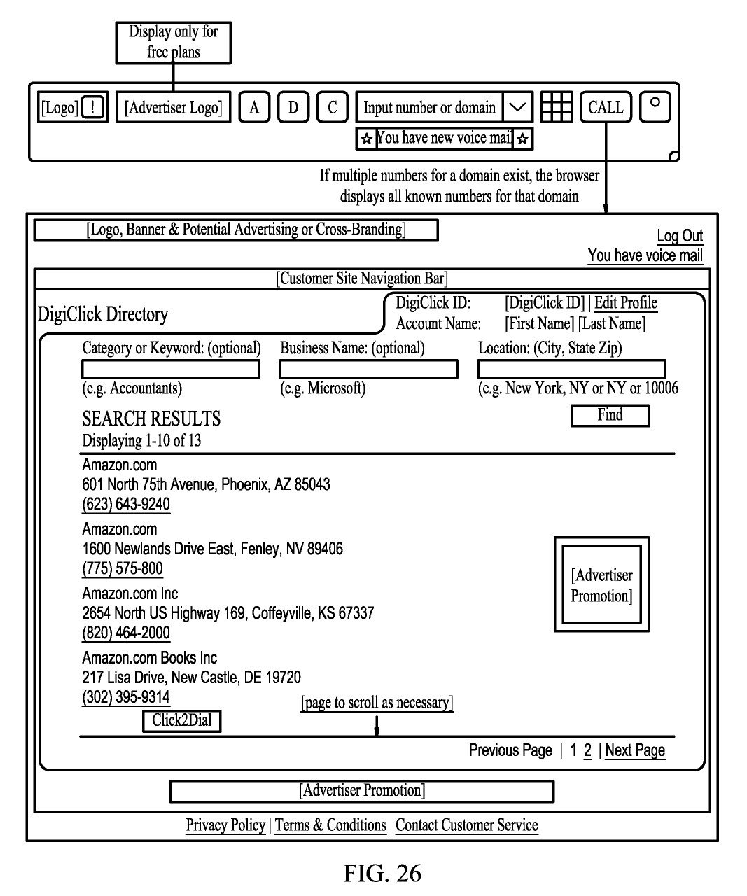

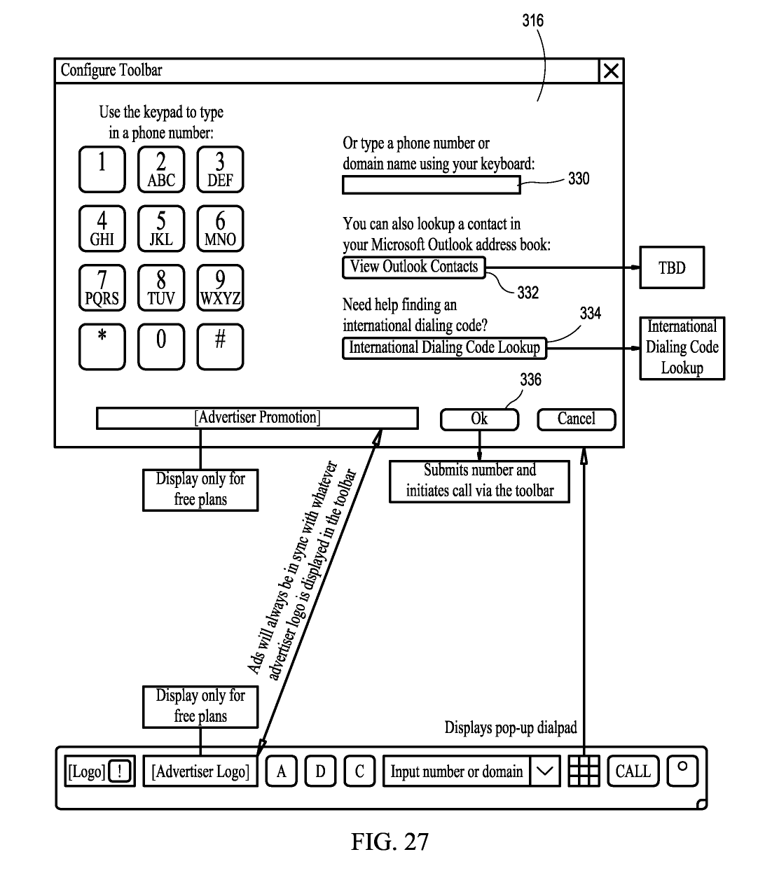

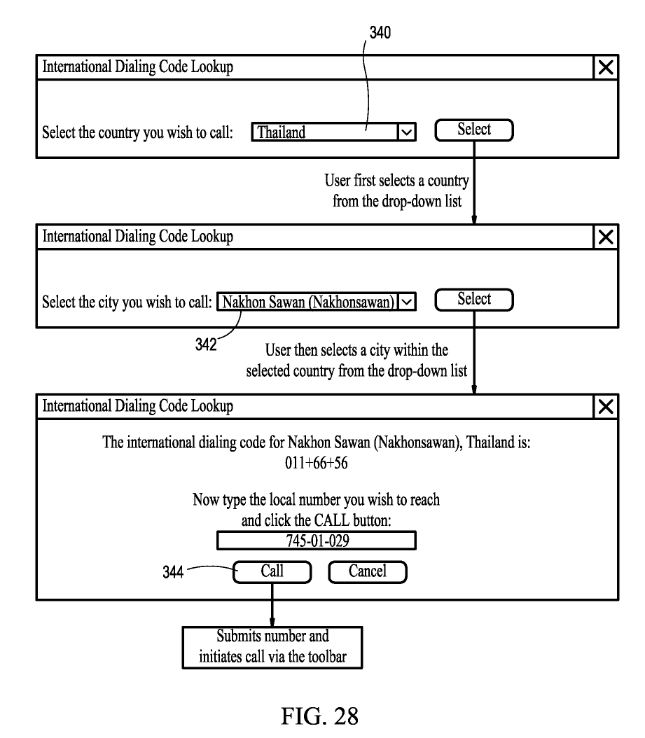

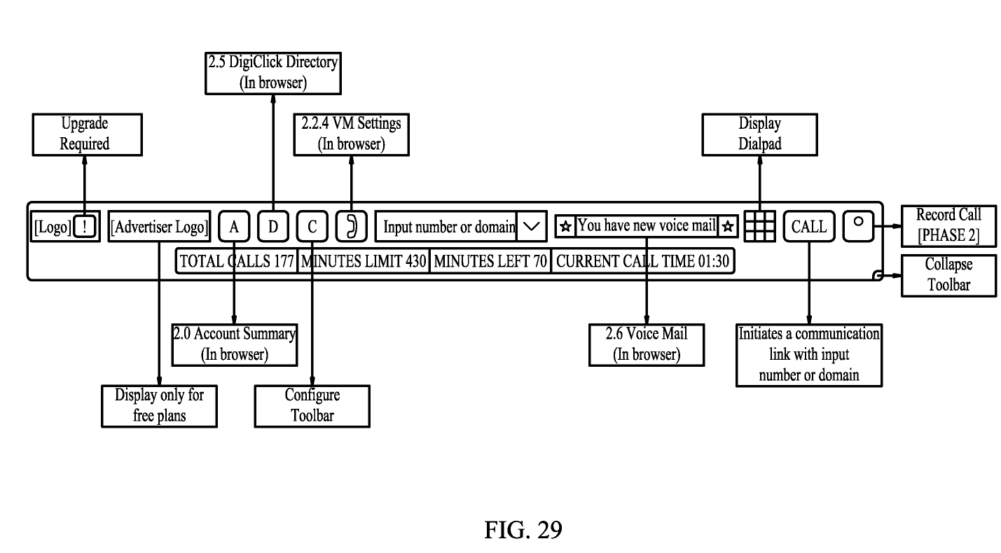

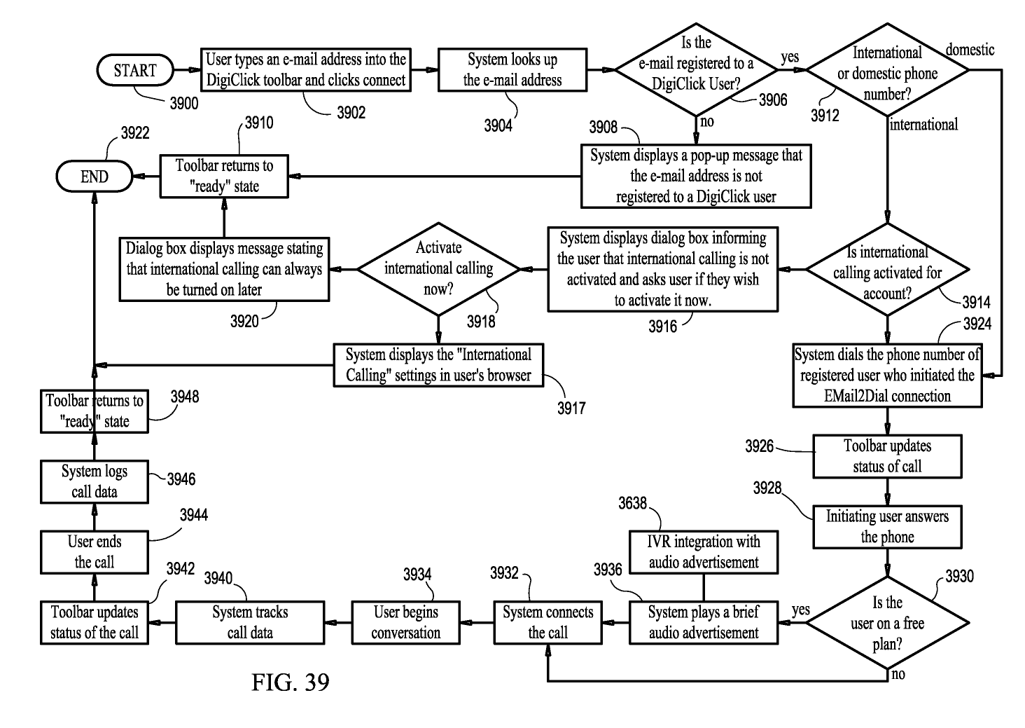

The present invention also envisions a call center, in which users can track and record the phone connection. Also, the toolbar of either user may update according to the status of said anonymous phone connection. FIGS. 19-29, depicts a toolbar according to the present invention. As shown, there may be a logo (300), an advertiser logo (302), account summary (304), directory (306), configure toolbar (308), voicemail settings (310), voicemail (312), drop down of input number or domain (314), display dialpad (316), record button (320). FIG. 20 depicts a screenshot of what may happen when you click on the account summary (304) button. FIG. 21 depicts a screen shot of what happens when you click on the Directory (306) button. FIG. 22 depicts the call (318) button screenshot. FIG. 23 depicts a screen shot of the configure toolbar (308). FIG. 24 depicts the voicemail settings (310) screen shot. FIG. 25 depicts the step of updating the toolbar according to the status of the phone connection. As shown, the user may click on the call (318) button. The drop down of the input number or domain or user id (314) may then indicate that the computer based system is initiating the call. At this point the toolbar display changes to show the call status and the call (318) button may change to say disconnect and show the number that the user is connected to. When the user hangs up the call button (318) may switch back to say call and numbers and or userID's may be stored in the drop down (314). FIG. 27 depicts the dialpad (316). As shown, you call dial in the numbers, type in the phone number or userID (domain) (330), you can also lookup a contact in your Microsoft outlook or other program (332), also you can connect to an outside or internal directory (334). FIG. 28 depicts a country code lookup, you can input the country you wish to call the city and input the local number (334) and press call (344). The computer based system will formulate the number to call and call the first user and the second user to connect the callers. FIG. 39 depicts a sample flowchart of a call from the toolbar and/or dialpad (316).

A method of providing anonymous calling, the method comprising the steps of: providing a first user having a first user ID associated with a first phone number; providing a second user having a second user ID associated with a destination phone number; accepting a text message from the first user containing the second user ID; determining the destination phone number locale status, wherein the destination phone number locale status is either domestic or international; wherein the destination phone number locale status is international, the method further comprises the step of determining the first users membership status, the first users membership status being selected from the group consisting of registered and paying, registered and free or unregistered; and wherein the first users membership status is registered and paying the step of calling the destination phone number is completed; wherein the first users membership status is registered and free the step of playing an advertisement to the user is performed and the step of calling the destination phone number is completed; wherein the first users membership status is unregistered, the initiating user is directed towards a membership application and the step of calling the destination phone number is not completed until the membership status is either registered and paying or registered and free; determining the destination membership status of the destination phone number, wherein the destination membership status is either registered or unregistered; wherein the destination membership status is registered the computer based system calls the destination phone number and an anonymous phone connection between the first user and the second user is completed; wherein the origination membership status is unregistered, the computer based system informs the connection cannot be made.

The method may comprise the step of tracking the anonymous phone connection and recording the anonymous phone connection. The data regarding the length of the call and an audio clip of the actual phone connection may be stored on either users account and viewable on their webpage. Also there may be the step of updating the toolbar of the first user according to the status of the anonymous phone connection.

The advertisement may be played on the on the first users or second users cell phone, hand held device, or computer.

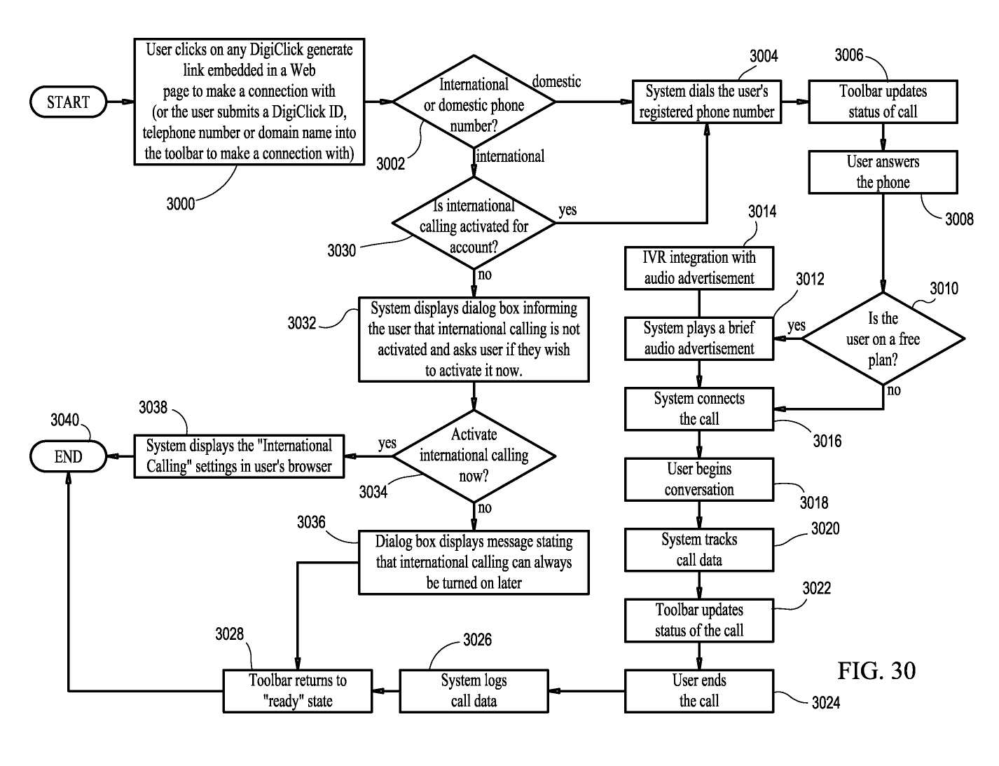

According to another embodiment, and with reference to FIG. 30 a method of providing anonymous web based calling is provided. The method comprising the steps of: providing a web page having an embedded call icon associated with a destination phone number; providing an initiating user, wherein the initiating user clicks on the embedded call icon (3000); calling the initiating user (3004); playing an advertisement to the initiating user (3012); and calling the destination phone number to provide an anonymous phone connection between the initiating user and the destination phone number (3016). The step of playing an advertisement (3012) may be on the initiating user or the destination users cell mobile, hand held device or computer.

The method may comprise the step of tracking the anonymous phone connection (3020). The information regarding the anonymous phone connection may be stored in the users account web page (3026). The method may further comprise the step of updating the toolbar of the initiating user according to the status of the anonymous phone connection (3022). The toolbar of the destination phone number may also be updated according to the status of the anonymous phone connection (3022). Once the call is ended (3024), the toolbar may return to the ready state (3028).

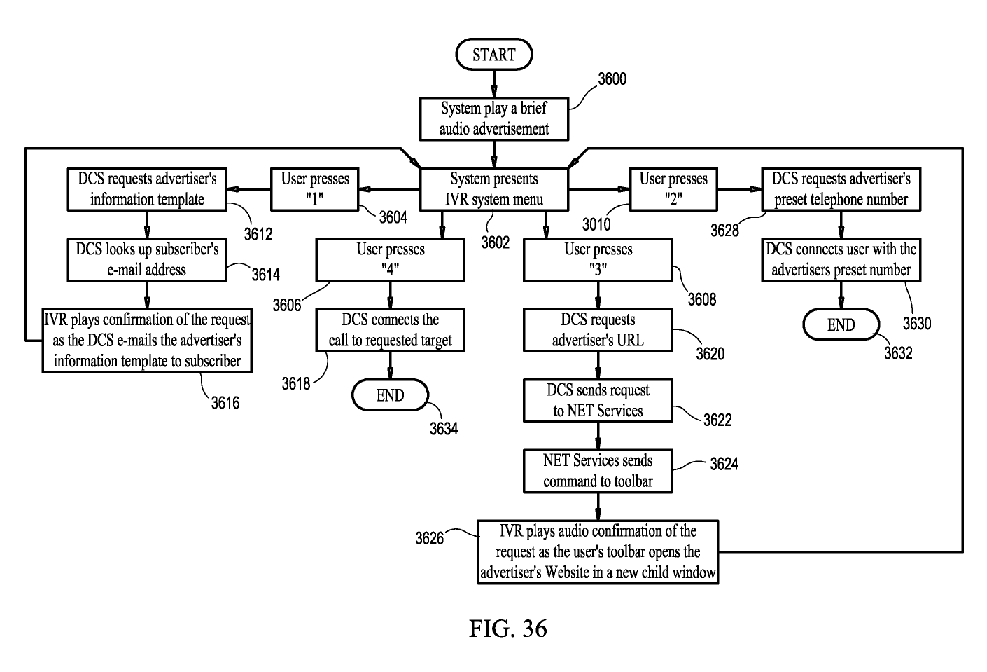

It may also be necessary to provide the step of: determining the destination phone number locale status (3002), wherein the destination phone number locale status is either domestic or international; wherein the destination phone number locale status is international, the method further comprises the step of determining the initiating users membership status (3030), the initiating users membership status being selected from the group consisting of registered and paying, registered and free or unregistered; and wherein the membership status is registered and paying the step of calling the destination phone number is completed (3004, 3006, 3008, 3010, 3016); wherein the membership status is registered and free the step of playing an advertisement to the user is performed and the step of calling the destination phone number is completed (3004, 3006, 3008, 3010, 3012, 3016); wherein the membership status is unregistered, the initiating user is directed towards a membership application (3032) and the step of calling the destination phone number is not completed until the membership status is either registered and paying or registered and free. The advertisement when the phone number locale status is international may be a longer advertisement or a more expensive advertisement. Also, the user may chose not to activate international calling (3036) and may be provided with a message that international calling may be turned on at a later time, the tool bar returns to ready status (3028) and the process is ended (3040). The method may also comprise the step of accepting an input from the first user's phone in response to the step of playing an advertisement. For example, the ad may say “American Airlines e-savers for this week are $69 from New York to Los Angeles, press “1” to make a reservation”. This may be accomplished via IVR integration (3014) with the audio advertisement. FIG. 36 depicts a sample IVR system menu. As shown, the system may play a brief audio advertisement (3600). The system presents IVR system menu (3602). The user may press or say 1 (3604). The DCS requests advertiser's information template (3612), the DCS looks up subscriber's email address (3614), IVR plays configuration of the request as the DCS emails the advertisers information to subscriber (3616). It the user selects “2” (3610), the DCS requests advertisers preset telephone number (3628), the DCS connects user with the advertisers preset number (3630). If the user selects “3” (3608), the DCS request the advertisers URL (3620), the DCS sends the request to the .NET services (3622), the .NET services sends command to the toolbar (3624), IVR plays audio confirmation of the request as the user's toolbar opens the advertisers website is in a new window (3626). If the user selects “3” (3608), the DCS requests advertiser's URL (3620), DCS sends request to .NET services (3622), .NET services sends command to toolbar (3624), IVR plays audio confirmation of the request as the user's toolbar opens the advertisers website in a new window (3626). As in any of the phone connections, it is envisioned that the method may comprise the step of recording the anonymous phone connection and providing information on all phone connections such as the length of the call.

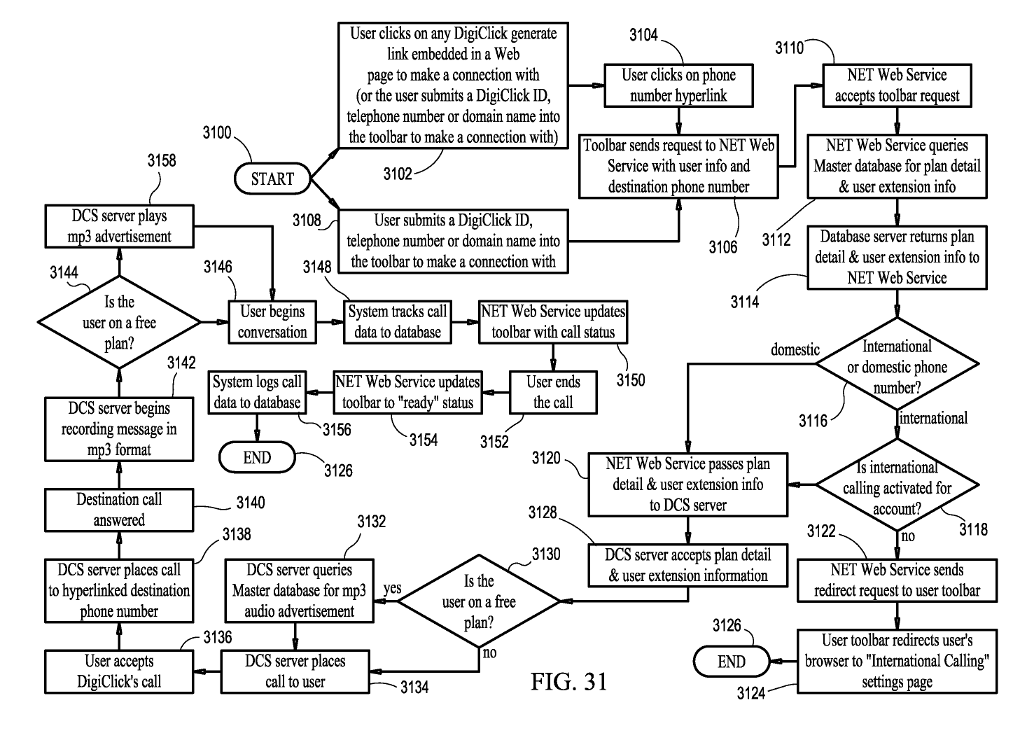

FIG. 31 depicts the manner in which the system may perform the method according to the present invention. As shown, the toolbar may parse the web page (3102) to make all phone number clickable hyperlinks. The user may click on the phone number hyperlink (3104). Alternatively, the user may submit a userID (telephone number, email address, domain name) to make a connection with (3108). The toolbar send the request (3106) to the .net web service with user info and destination phone number. The .net web service (3110) accepts the request (3110). The .net web service queries the mater database for plan detail and user extension info (3112). The database server returns plan detail and user extension for to the .net web service (3114). It is determined if the call is domestic or international ((3116). If the call is domestic, the .net web service passes plan detail and user extension info to the DCS server (3120). The DCS server accepts the plan detail and user extension information (3128). It is determined if the user is on a free plan (3130). If the user is on a free plan, the DCS server queries the Master database for an .mp3 audio advertisement (3132) Then the DCS server places the call to the first user (3134). If the user is not on a free plan, the DCS server places the call to the second user (3134). The first user accepts the call (3136), the DCS server places the call to the second or destination phone number (3138). The second user answers the call (3140). The DCS server begins recording in .mp3 format (3142). The system determines if the second user is on a free plan (3144). If the second user is on a free plan the DCS server plays an advertisement (3158). If the second user is not on a free plan, the conversation begins (3146) without playing an advertisement. The systems tracks call data to the database (3148), the .net web service updates the toolbar with call status (3150). When the user ends the call I(3152), the NET web service updates the toolbar to “ready” state (3154), the system logs the call data to the database (3156) and the call is ended (3126).

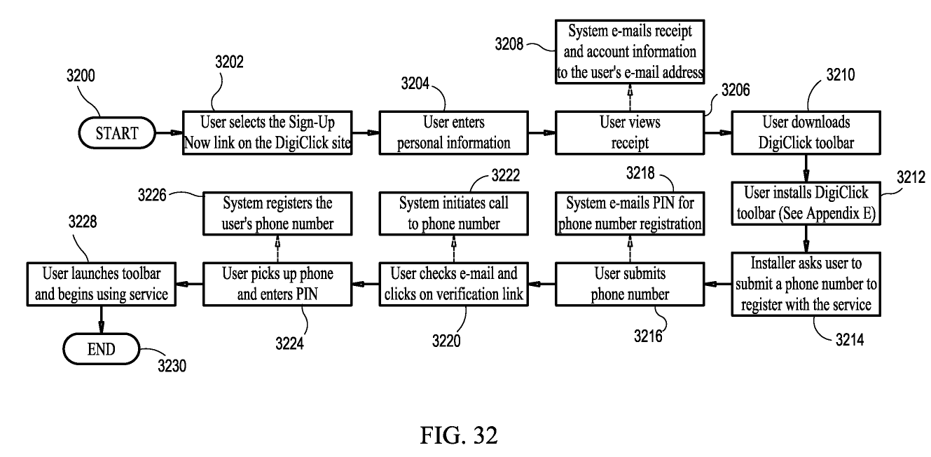

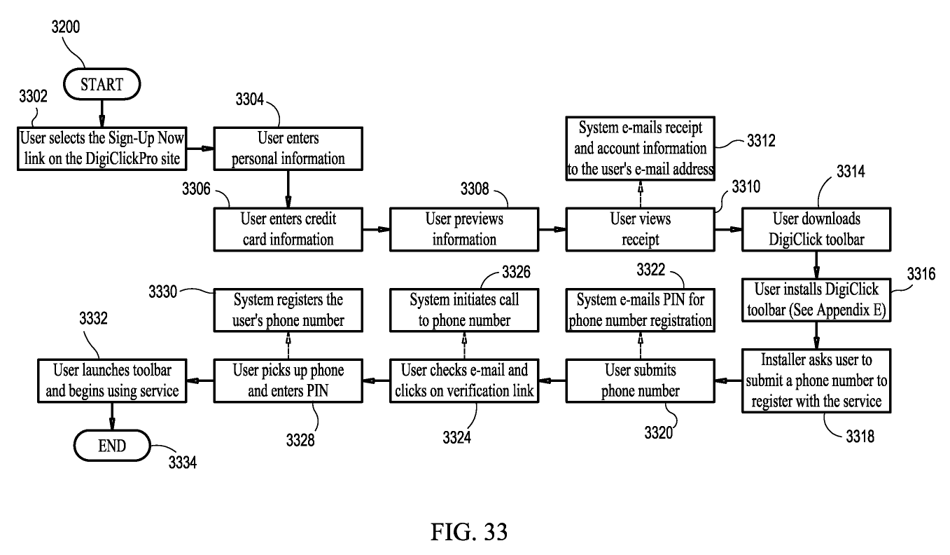

FIGS. 32-33 depicts the process of signing up to be a registered user. As shown, the user selects the sign-up now link on the website (3202). The user enters their personal information (3204). The user views the receipt (3206). The system emails receipts and information to the users account (3208). The user may also download the digiclick toolbar (3210). The user may install the toolbar (3212). The installer asks to submit a phone number (3214). The user submits a phone number (3216). The system emails a PIN for phone number registration (3218). The user checks email and clicks on verification link (3220). The system initiates call to phone number (3222). The user picks up phone and enters pin (3224), the system registers the user's phone number (3226). The user launches the toolbar and begins using service (3228). FIG. 33 depicts a higher level or Digiclick Pro account. As shown, the user selects the sign-up now (3302). The user enters information (3304), the user enters credit card information (3306), the user previews the information (3308), the user views the receipt (3310), the system emails the receipt and account information to the user's email address (3312). The user downloads the digiclick toolbar (3314), the user installs the toolbar (3316), the installer asks for a phone number (3318), the user submits the phone number (3320), the system emails a PIN for phone registration (3322), the user checks email and clicks on verification link (3324), the system initiates call to phone number (3326), the user picks up the phone and enters PIN (3328), the system registers the user's phone number (3330). The user launches the toolbar and begins using service (3332).

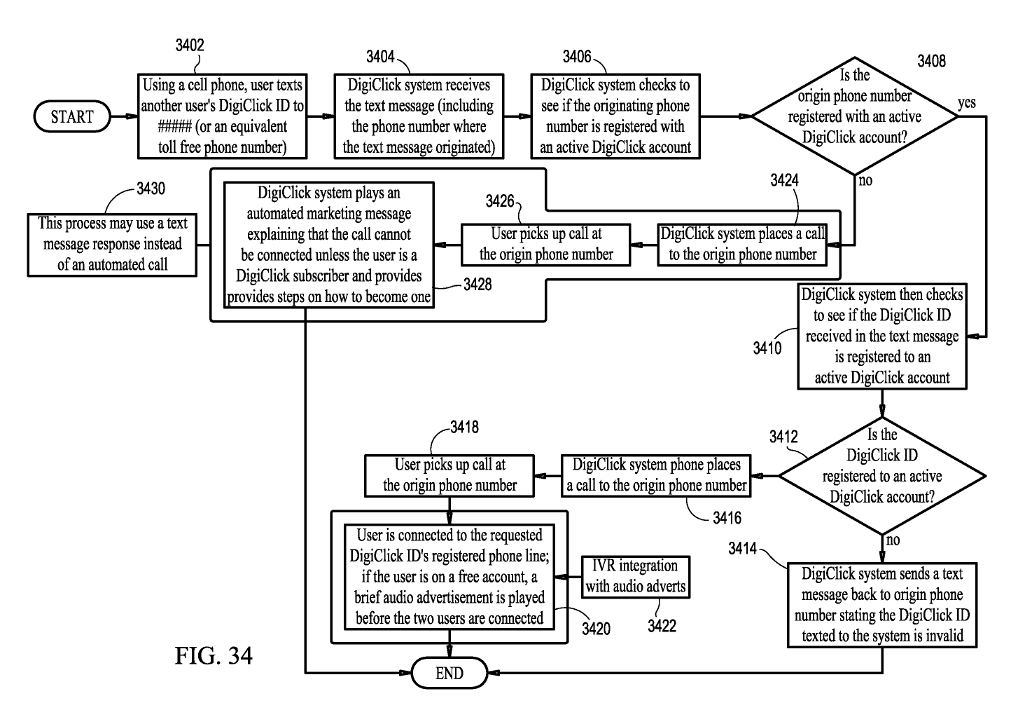

FIG. 34 depicts a method of providing a call, texting another user's ID to a number (3402), the system receives the text message (3404), the system checks to see if originating phone number is registered with an account (3406-3408). If the originating phone number is not registered the system places a call to the origin (or first user) phone number (3424), the first user picks up the call at the origin phone number (3426), the system play a marketing message (3428) explaining the call cannot be completed until they become a member and explains how to become a member. The process may user a text message response instead of a phone call (3430). If the origin phone number is registered, the system checks to see if the second user ID received is an active account or registered account (3410-3412). If the second user is not registered, the system sends a text message to the first user saying the ID is invalid (3414). If the second user is registered, the system places a call to the origin phone number (3416), the user pick up the phone (3418), the user is connected to the requested or second phone number (3420). If the User is on a free account, an advertisement is played prior to connecting the conversation (3420). IVR integration with audio advertisements (3422) may be used.

According to another embodiment, a method of providing anonymous web based calling is provided, the method comprising the steps of: providing a web page having an embedded call icon associated with a destination phone number; providing an initiating user, wherein the initiating user clicks on said embedded call icon; determining the destination phone number locale status, wherein the destination phone number locale status is either domestic or international; wherein the destination phone number locale status is international, the method further comprises the step of determining the initiating users membership status, the initiating users membership status being selected from the group consisting of registered and paying, registered and free or unregistered; and wherein the membership status is registered and paying the step of calling the destination phone number is completed to provide an anonymous phone connection between the initiating user and the destination phone number; wherein the membership status is registered and free the step of playing an advertisement to the user is performed and the step of calling the destination phone number is completed to provide an anonymous phone connection between the initiating user and the destination phone number; wherein the membership status is unregistered, the initiating user is directed towards a membership application and the step of calling the destination phone number is not completed until the membership status is either registered and paying or registered and free.

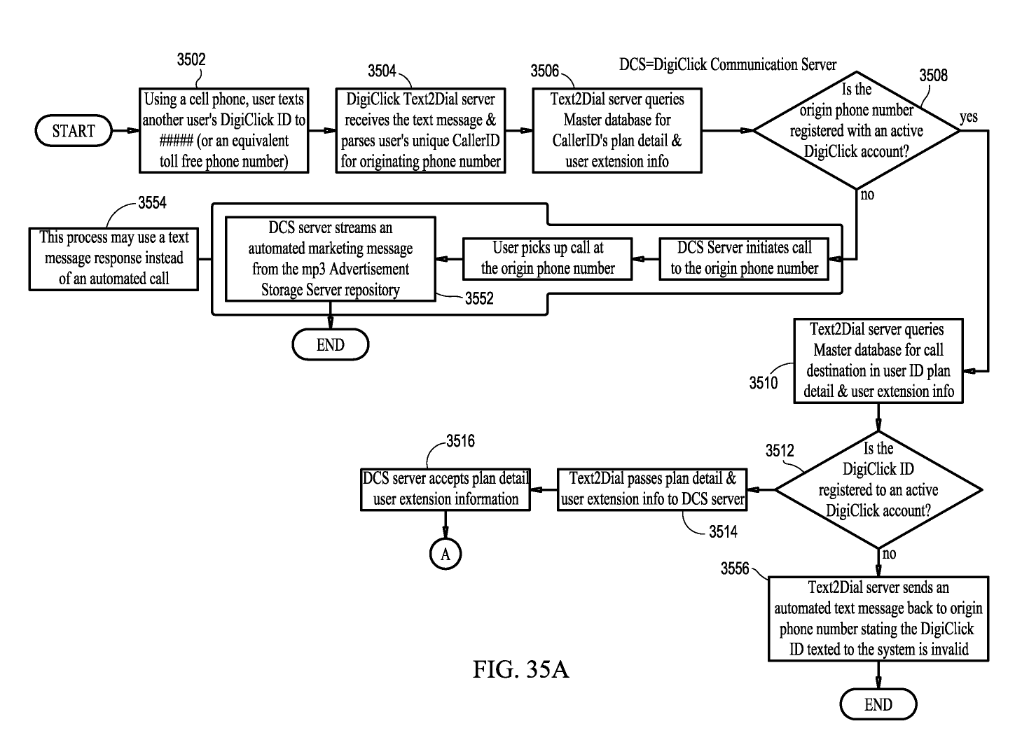

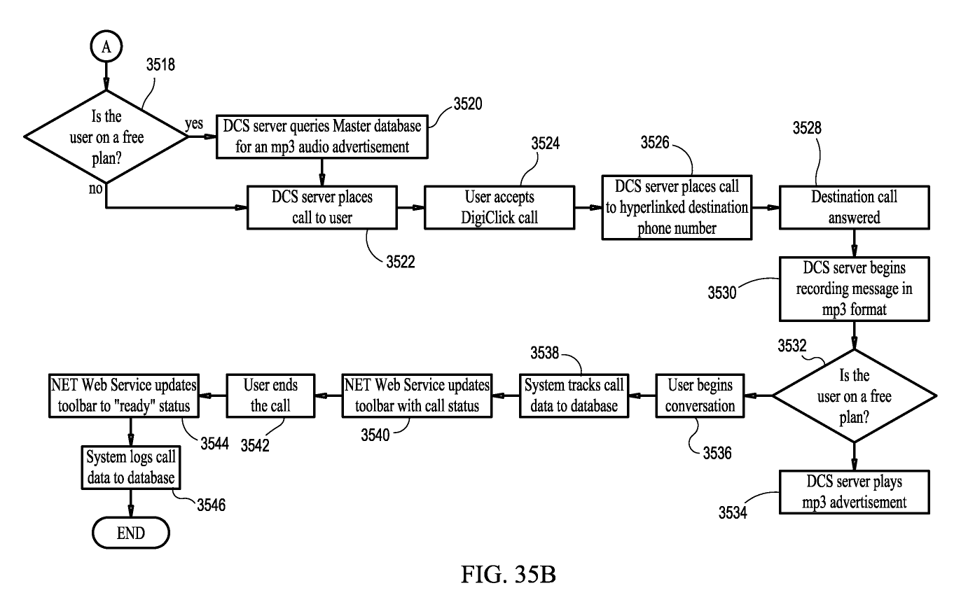

As shown in FIG. 35, using a cell phone a first user may text a second user's ID to a number (3502), the server receives the message and parses the first users callerid (3504), the server queries the master database for the plan detail associated with the callerID (3506) and determines if the origin phone number is registered with an active account (3508). If the first or origin phone number is not registered, the DCS server initiates a call to the first phone number (3548) the user picks up the call (3550), the DCS server streams an automated marketing message (3552). Steps 3548, 3550 and 3552 may also be sent via text message (3554). If the first user has a registered account, the server queries the master database (3510) for call destination userid plan detail and user extension information (3510). It is determined id the second user ID is registered to an active account (3512). If not, the server sends the first user an automated text message that the ID texted is invalid (3556). If the ID is an active account, the system parses plan detail and user extension info to the DCS server (3514). The DCS server accepts plan detail and user extension information (3516). It is determined if the user is on a free plan (3518). If the user is on a free plan, the DCS server queries the master database for an advertisement (3520). The DCS server places a call to the user (3522). The user accepts the call (3524). The server places the call to the hyperlinked second or destination phone number (3526). The destination call is answered (3528). The DCS server begins recording (3530). It is determined if the second user is on a free plan (3532). If the second or destination user is on a free plan, the DCS server plan an advertisement (3534). If the second or destination user is not on a free plan, the users begin their conversation (3536), the system tracks the call data to a database (3538); the .NET web service updates the toolbar according to the call status (3540). Once the user ends the call (3542), the .NET web service updates the toolbar to a “ready” state (3544). The system logs the call data to a database (3546).

According to another embodiment, a system of providing anonymous calling is provided, the system comprising: a first user having a first user ID associated with a first phone number and a first user plan stored in the computer based system; a second user having a second user ID associated with a destination phone number and a second user plan in the computer based system; wherein the computer based system accepts a call request from the first user containing the second user ID and determines the registration status of the second user and the destination phone number; wherein the registration status of the destination phone number is not registered the first user is notified that the second userID is invalid; wherein the registration status of destination phone number is registered, the computer based system determines whether the destination phone number is a domestic or international call to the first user and determines whether the first user is on a paid plan or a free plan, and wherein the first user is on a free plan, an advertisement is played to the initiating user prior to placing phone call and wherein the first user is on a paid plan the advertisement is not played and the first user is called and the first user is billed for the phone call; the computer based system initiates a call between by calling the first phone number and the destination phone number and connecting the first user and the second user to provide an anonymous phone connection between the first user and the destination phone number.

The first user plan may be free, free and international, paid, paid and international. The first user toolbar resident on the first user's computer. The second user toolbar resident on the second user's computer.

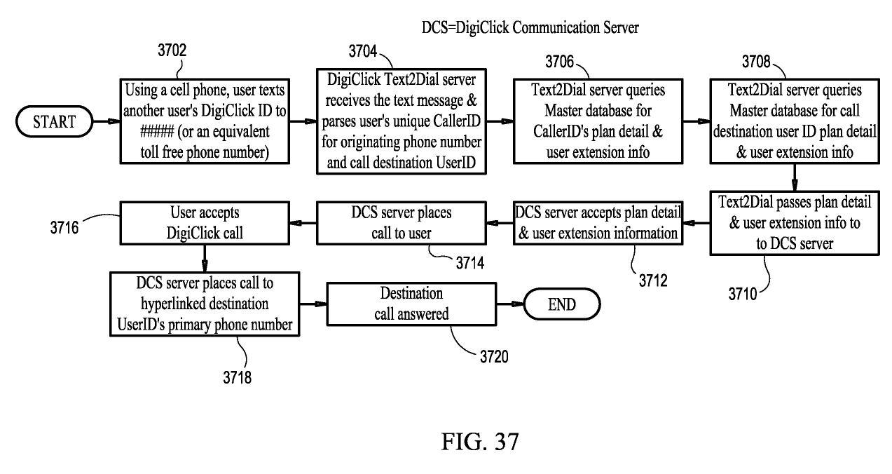

FIG. 37 depicts a call request according to the present invention. As shown, using a cell phone a first user may text another user's ID to a number (3702), the server receives the text message and parses the phone number for the first user and the second user (3704), the server queries the master database for the plan detail according to the callerID of the first user (3706), the server queries the amster database for the plan detail of the second (or destination) user (3708). The plan detail and user extension info is parsed into the DCS server (3710). The DCS server accepts the plan detail and user information (3712). The DCS server places the call to the user (3714). The first user accepts the call (3716), the DCS server places the call to the hyperlinked destination users phone number (3718) and the destination or second user's call is answered (3720) and a connection is made between the first user and second user.

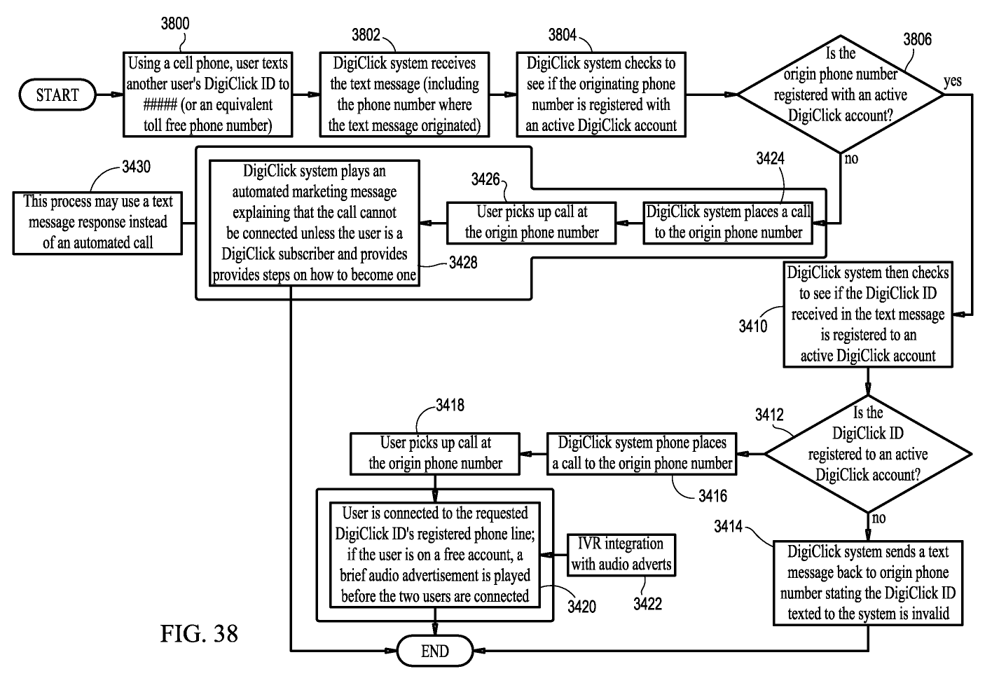

The call request may be made or requested through a web page input, mobile device input, or any other input device. FIG. 38 depicts a flowchart according to the present invention and comprises the steps of: a first user, using a cell phone texts a second user ID (email address) to a text number of equivalent toll free phone number (3800), receiving the text message by the system (3802), the system checks to see if the originating phone number (first user) is registered with an active account (3804 and 3806). If the originating phone number is not registered, the system places a call to the origin phone number (3810), the user picks up the call at the origin phone number (3812), an automated marketing message (or advertisement) is played (3814) stating that the call cannot be connected unless the user is a subscriber and describes how to become one. Steps (3810, 3812 and 3814) may also be text messaged (3816). This is the end (3824) of the attempted phone call until the originating user becomes a member. If the origin phone number is registered, the system checks (3818) to see if the second user (ID or email address) is registered to an active account (3820). If the account is not active, the system sends a text message back to the origin phone number stating that the email address texted to the system is invalid (3822). If the account is active, the system places a call to the original phone number (3826), the first user picks up the phone call at the original (or first) phone number (3828). The first user is connected to the phone line registered to the second email address (3830). If the second user is on a free account, an advertisement played before the two users are connected. There may also be IVR (integrated voice response) integration with audio advertisements (3832). And the steps would end (3824).

FIG. 39 depicts a sample flowchart of the method according to a first user dialing from their computer toolbar. As shown, the user may type an email address (or user ID) into the toolbar and click connect (3902), the system would look up the email address (3904), the system would determine if the email is registered (3906). If the email is not registered, the system would display a message that the email is not registered (3908), the toll bar would return to a ready state (3910). If the email is registered to a user, the next step would be to determine if the destination phone number is international or domestic (3912). If the phone number is domestic, the system dials the phone number of the user who initiated the connection (3924), the toolbar would be updated as to the status of the call (3926), the initiating user would answer their phone (3928). The system would determine if the initiating user is on a free plan (3930). If the user is on a free plan, the system would play a brief audio advertisement (3936) and then connect the call (3932). If the user is not on a free plan the system would connect the call (3932). The conversation would begin (3934). The system would track the call data (3940), the toolbar would update the status of the call (3940). Once the call was ended (3944), the toolbar would update the status of the call (3946) and the toolbar would return to the ready state (3948) and end (3922).

It should be understood that the foregoing relates to preferred embodiments of the invention and that modifications may be made without departing from the spirit and scope of the invention as set forth in the following claims.

I claim:

1. A method of providing anonymous calling, said method comprising the steps of:
providing a first user having a first user ID associated with a first phone number;
providing a second user having a second user ID associated with a destination phone number;
accepting an call request from said first user containing said second user ID;
receiving in a computer based system said call request, wherein said computer based system checks to inquire whether said destination phone number is registered with said computer based system, wherein said destination phone number is not registered said first user is notified that said second userID is invalid, wherein said destination phone number is registered, said method comprises the step determining whether said first user is on a paid plan or a free plan, and wherein said first user is on a free plan, an advertisement is played to said first user prior to calling said first user and wherein said first user is on a paid plan said advertisement is not played and said step of calling said first user is performed;
calling said destination phone number and providing a telephone connection between said first user and said second user to provide an anonymous phone connection between said first user and said second user.

2. A method as in claim 1, further comprising the step of:
tracking said anonymous phone connection.

3. A method as in claim 1, further comprising the step of:
updating the toolbar of said first user according to the status of said anonymous phone connection.

4. A method as in claim 1, wherein said step of playing an advertisement is played on said first users cell phone.

5. A method as in claim 1, wherein said step of playing an advertisement is played on said first users computer.

6. A method as in claim 1, wherein said step of playing an advertisement is played on said first users hand held device.

7. A method as in claim 1, further comprising the step of:
recording said anonymous phone connection.

8. A method as in claim 1, further comprising the step of:
accepting a voicemail in said second user's voicemail.

9. A method as in claim 8, further comprising the step of:
rating said voicemail.

10. A method as in claim 1, further comprising the step of:
finding a userID by searching a registered user directory.

11. A method as in claim 1, wherein said first user ID is an email address.

12. A method as in claim 1, wherein said second user ID is an email address.

13. A method of providing anonymous calling, said method comprising the steps of:
providing a first user having a first user ID associated with a first phone number;
providing a second user having a second user ID associated with a destination phone number;
accepting a text message from said first user containing said second user ID;
determining the destination phone number locale status, wherein said destination phone number locale status is either domestic or international;
wherein said destination phone number locale status is international, said method further comprises the step of determining said first users membership status, said first users membership status being selected from the group consisting of registered and paying, registered and free or unregistered; and
wherein said first users membership status is registered and paying the step of calling said first user phone number is completed;
wherein said first users membership status is registered and free said step of playing an advertisement to said user is performed and said step of calling said first user phone number is completed;
wherein said first users membership status is unregistered, said first user is directed towards a membership application and the step of calling said first phone number is not completed until said membership status is either registered and paying or registered and free;
determining the destination membership status of said destination phone number, wherein said destination membership status is either registered or unregistered;
wherein said destination membership status is registered said computer based system calls said first phone number and said destination phone number and an anonymous phone connection between said first user and said second user is completed;
wherein said origination membership status is unregistered, said computer based system informs said first user said connection cannot be made.

14. A method as in claim 13, wherein said first user ID is an email address.

15. A method as in claim 13, wherein said second user ID is an email address.

16. A method as in claim 13, further comprising the step of:
tracking said anonymous phone connection.

17. A method as in claim 13, further comprising the step of:
updating the toolbar of said first user according to the status of said anonymous phone connection.

18. A method as in claim 13, wherein said step of playing an advertisement is played on said first users cell phone.

19. A method as in claim 13, wherein said step of playing an advertisement is played on said first users computer.

20. A method as in claim 13, wherein said step of playing an advertisement is played on said first users hand held device.

21. A method as in claim 13, further comprising the step of:
recording said anonymous phone connection.

22. A method as in claim 13, further comprising the step of:
finding a second userID by searching a registered user directory.

23. A method as in claim 13, further comprising the step of:
accepting a voicemail in said second user's voicemail.

24. A method as in claim 13, further comprising the step of:
rating said voicemail.
